(19) United States
(12) Patent Application Publication
(10) Pub. No.: US 2002/0197456 A1
(43) Pub. Date: Dec. 26, 2002

(54) Integrated electro-luminescent biochip

(76) Inventor: Edward J. A. Pope, Agoura, CA (US)

Correspondence Address: W. Edward Johansen, 11661 San Vicente Boulevard, Los Angeles, CA, 90049, US

(21) Appl. No.: 09/965,683

(22) Filed: Sep. 27, 2001

Related U.S. Application Data
(63) Continuation-in-part of application No. 08/112,398, filed on Aug. 26, 1993, now abandoned.
Application No. 08/112,398 is a continuation-in-part of application No. 08/560,380, filed on Nov. 17, 1995, now Pat. No. 5,757,124.
Application No. 08/560,380 is a division of application No. 08/084,876, filed on Jun. 30, 1993, now Pat. No. 5,480,582.

(51) Int. Cl. G01J 1/00; B32B 3/00; B32B 9/00

(52) U.S. Cl. 428/209; 428/446; 428/690; 250/200

(57) ABSTRACT

A biochip includes a plurality of sensors. Each sensor contains one or more light sources and one or more optical detectors.

This is a continuation-in-part of an application filed Jul. 8, 1998 under Ser. No. 08/112,398, which is a continuation-in-part of an application filed Nov. 17, 1995 under Ser. No. 08/560,380, which is a divisional application of a patent application filed Jun. 30, 1993 under Ser. No. 08/084,876.

### BACKGROUND OF THE INVENTION

The invention relates to the field of detectors for analysis of biological samples located on biochips.

U.S. Pat. No. 5,770,029 teaches an integrated electro-phoretic micro-devices each of which includes at least an enrichment channel and a main electro-phoretic flow-path are provided. In the subject integrated devices, the enrichment channel and the main electro-phoretic flow-path are positioned so that waste fluid flows away from said main electro-phoretic flow-path through a discharge outlet. The subject devices find use in a variety of electro-phoretic applications, including clinical assays.

U.S. Pat. No. 6,159,681 teaches compositions and methods which are provided for performing regional analysis of biologic materials. The methods provided herein employ a photo-resist layer that is established over a biologic material (which may be immobilized on a substrate). Regions of interest are selected and irradiated to expose specific regions of biologic material. Exposed biologic material may then be selectively analyzed using any of a variety of analytic methods.

U.S. Pat. No. 6,160,618 teaches an apparatus for analyzing samples on a slide which includes a slide mover positioned to hold a slide, a imaging spectrometer positioned in the path of light from the slide to split the light line into a light array, a light amplifier may be positioned between the imaging spectrometer and a camera, is disclosed. The camera can detect the entire spectrum of light produced by the imaging spectrometer.

U.S. Pat. No. 6,110,676 teaches methods which are qsuitable for detection, analysis and quantitation of nucleic acid target sequences using probe based hybridization assays and more specifically for suppressing the binding of detectable nucleic acid probes or detectable PNA probes to non-target nucleic acid sequences in an assay for a target nucleic acid sequence to thereby improve the reliability, sensitivity and specificity of the assay. The methods, kits and compositions of this invention are particularly well suited to the detection and analysis of nucleic acid point mutations.

U.S. Pat. No. 6,245,507 teaches a hyper-spectral imaging apparatus. The apparatus employs an apparatus for multi-dye/base detection of a nucleic acid molecule coupled to a solid surface.

U.S. Pat. No. 6,245,506 teaches the use of the discovery that the sequence of monomers in a polymeric biomolecule can be determined in a self-contained, high pressure reaction and detection apparatus, without the need for fluid flow into or out from the apparatus. The pressure is used to control the activity of enzymes that digest the polymeric biomolecule to yield the individual monomers in the sequence in which they existed in the polymer. High pressures modulate enzyme kinetics by reversibly inhibiting those enzymatic processes. These processes result in a higher average activation volume, when compared to the ground state, and reversibly accelerating those processes which have lower activation volumes than the ground state. Modulating the pressure allows the experimenter to precisely control the activity of the enzyme. Conditions can be found, for example, where the enzyme removes only one monomer (e.g., a nucleotide or amino acid) from the biomolecule before the pressure is again raised to a prohibitive level. The identity of the single released nucleotide or amino acid can be determined using a detector that is in communication with a probe in the detection zone within the reaction vessel.

U.S. Pat. No. 6,240,790 teaches a microanalysis device. The device has a plurality of sample processing compartments is described for use in liquid phase analysis. A microanalysis device system, comprising a plurality of interconnected microanalysis devices. The device is formed by microfabrication of microstructures in novel support substrates.

Detection devices that detect and locate samples contained on a biochip via laser light sources and laser scanners are well known in the art. These detection devices require the samples to be labeled by a fluorescent tag. Typically, these detection devices rely on laser light sources to excite the samples that are labeled by a fluorescent tag and causes biologically active samples to output emitted light waves. The laser source is scanned to serially excite each sample on the biochip to detect any emitted light waves from the samples that are biologically active. Unfortunately, these detection devices utilizing either the laser light source or the laser scanner suffers from various drawbacks. First, laser scanners utilized to detect the emitted light waves from the exited samples on the biochip typically require wait times upwards of five minutes for sufficient resolution. Because laser scanners operate as a serial scanning device by sequentially detecting one sample at a time on the surface of the biochip, laser scanners are inherently inefficient at detecting the emitted light waves from an array of samples.

Further, laser light sources utilized within the detection devices inherently only emit coherent light-waves. The light-waves span over an extremely narrow range of wavelengths. Fluorescent tags are generally responsive to a single frequency of light or light from a narrow frequency band. Thus, the use of the laser light sources severely limits the flexibility of those detection devices because only one type of fluorescent tag can be used. In order to use other tags additional laser sources must be used. In order to evaluate a biochip that has been treated with multiple tags, a long duration scan cycle must be performed for each one of the required laser sources. If samples on a biochip were labeled with two different fluorescent tags and the different tags required light waves with substantially different excitation wavelengths, analyzing these samples would require the user to change laser light sources the analysis of all the samples were completed. Additionally, to be able to handle samples labeled with different fluorescent tags with differing excitation wavelengths, the user is required to have access to a variety of laser light sources. Since laser light sources are costly and specialized items, there are substantial costs and inconveniences associated with utilizing these prior detection devices.

Therefore, it is desirable to have an ability to detect and locate samples labeled with multiple tags contained on a biochip, without the need for a laser light source. It is also desirable have an ability to detect and locate samples labeled with a tag contained on a biochip, without the need for a serial scanning device.

U.S. Pat. No. 6,197,503 teaches a self-contained miniature DNA biosensor. The biosensor detects specific molecular targets, particularly suitable for detection of nucleic acids. Hybridized DNA may be detected without external monitoring or signal transmission. The biosensor is a biochip and includes multiple biological sensing elements such as DNA probes, excitation micro-lasers, a sampling wave-guide equipped with optical detectors (fluorescence and Raman), integrated electro-optics, and a bio-telemetric radio frequency signal generator. The novel integrated circuit biochip micro-system (ICBM) is suitable for gene analysis and will allow rapid, large-scale and cost-effective production of gene biochips.

U.S. Pat. No. 6,280,946 teaches PNA probes. The probes pertain to the universal detection of bacteria and/or eucarya. Preferred universal probes for the detection of bacteria comprise a probing nucleo-base sequence selected from the group consisting of CTG-CCT-CCC-GTA-GGA; TAC-CAG-GGT-ATC-TAA-T; CAC-GAG-CTG-ACG-ACA and CCG-ACA-AGG-AAT-TTC. Preferred universal probes for the detection of eucarya include a probing nucleo-base sequence selected from the group consisting of ACC-AGA-CTT-GCC-CTC-C; GGG-CAT-CAC-AGA-CCT-G; TAG-AAA-GGG-CAG-GGA and TAC-AAA-GGG-CAG-GGA. The PNA probes, probe sets, methods and kits of this invention are particularly well suited for use in multiplex PNA-FISH assays wherein the bacteria and/or eucarya in a sample can be individually detected, identified or quantitated. Using exemplary assays described herein, the total number of colony forming units (CFU) of bacteria and/or eucarya can be rapidly determined.

U.S. Pat. No. 6,238,624 teaches a self-addressable, self-assembling microelectronic device. The device is designed and fabricated to actively carry out and control multi-step and multiplex molecular biological reactions in microscopic formats. These reactions include nucleic acid hybridizations, antibody/antigen reactions, diagnostics, and biopolymer synthesis. The device can be fabricated using both micro-lithographic and micro-machining techniques. The device can electronically control the transport and attachment of specific binding entities to specific micro-locations. The specific binding entities include molecular biological molecules such as nucleic acids and polypeptides. The device can subsequently control the transport and reaction of analytes or reactants at the addressed specific micro-locations. The device is able to concentrate analytes and reactants, remove non-specifically bound molecules, provide stringency control for DNA hybridization reactions, and improve the detection of analytes. The device can be electronically replicated.

U.S. Pat. No. 6,271,042 teaches a biochip detection system. The biochip detection system detects and locates samples that are labeled with multiple fluorescent tags and are located on a biochip. This biochip detection system includes a charge coupled device (CCD) sensor, a broad-spectrum light source, a lens, a light source filter, and a sensor filter. The CCD sensor includes two-dimensional CCD arrays to simultaneously detect light waves from at least a substantial portion of the biochip. The broad-spectrum light source is optically coupled to the CCD sensor and is configured to be utilized with a variety of different fluorescent tags. The tags have differing excitation wavelengths.

U.S. Pat. No. 4,983,369 a process for producing highly uniform microspheres of silica having an average diameter of 0.1-10 microns from the hydrolysis of a silica precursor, such as tetraalkoxysilanes, which is characterized by employing precursor solutions and feed rates which initially yield a two-phase reaction mixture.

U.S. Pat. No. 4,943,425 teaches a method of making high purity, dense silica of large particles size. Tetraethylorthosilicate is mixed with ethanol and is added to a dilute acid solution having a pH of about 2.25. The resulting solution is digested for about 5 hours, then 2N ammonium hydroxide is added to form a gel at a pH of 8.5. The gel is screened through an 18-20 mesh screen, vacuum baked, calcined in an oxygen atmosphere and finally heated to about 1200 C in air to form a large particle size, high purity, dense silica.

U.S. Pat. No. 4,965,x91 teaches a sol-gel procedure is described for making display devices with luminescent films. The procedure typically involves hydrolysis and polymerization of an organo-metallic compound together with selected luminescent ions, and coating of a substrate and then heat treatment to form a polycrystalline layer.

U.S. Pat. No. 4,931,312 teaches luminescent thin films which are produced by a sol-gel process in which a gellable liquid is applied to a substrate to form a thin film; gelled and heated to remove volatile constituents and form a polycrystalline luminescent material.

U.S. Pat. No. 4,997,286 teaches an apparatus for measuring temperature in a region of high temperature which includes a sensor made from a fluorescent material, located within the region of high temperature. The fluorescent decay time of the fluorescent material is dependent upon the temperature of the fluorescent material.

U.S. Pat. No. 4,948,214 teaches an array of individual light emitters of a LED linear array each of which is imaged by a discrete step-index light guide and gradient index micro-lens device. The light guides consist of high refractive index cores each surrounded by low refractive index matter. A multiplicity of light guides are deposited in channels formed in a host material, such as a silicon wafer. The host material between adjacent channels functions as an opaque separator to prevent cross-talk between adjacent light guides.

U.S. Pat. No. 4,925,275 teaches a liquid crystal color display which provides a transmitted light output that is of one or more-colors, black, and/or white, as a-function of the color of the incident light input and controlled energization or not of respective optically serially positioned liquid crystal color layers and/or -multicolor composite liquid crystal color layer(s) in the display. In one case the display includes a plurality of liquid crystal color layers each being dyed a different respective color, and apparatus for selectively applying a prescribed input, such as an electric field, to a respective layer or layers or to a portion or portions thereof. Each liquid crystal layer includes plural volumes of operationally nematic liquid crystal material in a containment medium that tends to distort the natural liquid crystal structure in the absence of a prescribed input, such as an electric field, and pleochroic dye is included or mixed with the liquid crystal material in each layer. Each layer is differently colored by the dye so as to have a particular coloring effect on light incident thereon. Exemplary layer colors may be yellow, cyan and magenta.

U.S. Pat. No. 4,957,349 teaches an active matrix screen for the color display of television images or pictures, control system which utilizes the electrically controlled birefringence effect and includes an assembly having a nematic liquid crystal layer with a positive optical anisotropy between an active matrix having transparent control electrodes and a transparent counter electrode equipped with colored filters and two polarizing means, which are complimentary of one another and are located on either side of the assembly.

U.S. Pat. No. 4,948,843 teaches dye-containing polymers in which the dyes are organic in nature are incorporated into glasses produced by a sol-gel technique. The glasses may be inorganic or organic-modified metal oxide heteropolycondensates. The dye-containing polymers are covalently bonded to the glass through a linking group. These products can be used to make optically clear colored films which can be employed in the imaging, optical, solar heat energy and related arts.

U.S. Pat. No. 5,598,058 teaches a thick-film multi-color electroluminescent display which includes a transparent substrate, a transparent electrode deposited on the substrate, a phosphor layer deposited on the transparent electrode having two regions having different compositions providing visually distinct spectra of light when placed in a common electric field, a dielectric layer deposited on the phosphor layer, and a second electrode deposited on the dielectric layer. The phosphor layer may be composed of a marbled-ink having a mixture of a first phosphor ink and a second phosphor ink having different compositions providing visually distinct spectra of light when placed in a common electric field. The phosphor layer may be composed of at least two halftone screen prints corresponding to at least two phosphor compositions providing visually distinct spectra of light when placed in a common electric field.

U.S. Pat. No. 5,602,445 teaches a bright, short wavelength blue-violet phosphor for electroluminescent displays which includes an alkaline-based halide as a host material and a rare earth as a dopant. The host alkaline chloride can be chosen from the group II alkaline elements, particularly strontium chloride (SrCl.sub.2) or calcium chloride (CaCl.sub.2), which, with a europium (Eu) or cerium (Ce) rare earth dopant, electroluminesces at a peak wavelength of 404 and 367 nanometers (nm) respectively. The resulting emissions have CIE chromaticity coordinates which lie at the boundary of the visible range for the human eye thereby allowing a greater range of colors for full color flat panel electroluminescent (FPEL) displays.

U.S. Pat. No. 5,719,467 teaches an organic electroluminescent device which has a conducting polymer layer beneath the hole-transport layer. A conducting polymer layer of doped polyaniline (PANI) is spin-cast onto an indium-tin oxide (ITO) anode coating on a glass substrate. Then a hole-transport layer, for example TPD or another aromatic tertiary amine, is vapor-deposited onto the conducting polymer layer, followed by an electron transport layer and a cathode. Polyester may be blended into the PANI before spin-casting and then removed by a selective solvent after the spincasting leaving a microporous l/ayer of PANI on the anode. The conducting polymer layer may instead be made of a pi-conjugated oxidized polymer or of TPD dispersed in a polymer binder that is doped with an electron-withdrawing compound. An additional layer of copper-phthalocyanine, or of TPD in a polymer binder may be disposed between the conducting polymer layer and the hole transport layer. The conducting polymer layer may serve as the anode, in which case the ITO is omitted.

U.S. Pat. No. 5,717,289 teaches a thin film electroluminescent element which has a color changing layer doped with green luminescent material and red fluorescent material and separated from an electroluminescent layer for generating blue light for converting the blue light to green light and the green light to red light, and the separation results in reduction of trapping center in the electro-luminescent layer.

U.S. Pat. No. 5,711,898 teaches a blue-green emitting ZnS: Cu, Cl phosphor which is made by doping the phosphor with small amounts of gold and increasing the amount of low intensity milling between firing steps. The phosphor has better half-life and brightness characteristics while maintaining its desired emission color.

U.S. Pat. No. 5,705,888 teaches an electro-luminescent device which is composed of polymeric LEDs having an active layer of a conjugated polymer and a transparent pelymeric electrode layer having electro-conductive areas as electrodes. Like the active layer, the electrode layer can be manufactured in a simple manner by spin coating. The electrode layer is structured into conductive electrodes by exposure to UV light. The electrodes jointly form a matrix of LEDs for a display. When a flexible substrate is used, a very bendable EL device is obtained.

U.S. Pat. No. 5,705,285 teaches an organic electro-luminescent display device which includes a plurality of pixels including a substrate upon which is disposed on a plurality of different light influencing elements. Deposited atop each light-influencing element is an organic electroluminescent display element which is adapted to emit light of a preselected wavelength. A layer of an insulating, planarizing material may optionally be disposed between the light influencing elements and the OED. Each light-influencing element generates a different effect in response to light of a preselected incident thereon. In this way, it is possible to achieve a red, green, blue organic electroluminescent display assembly using a single organic electroluminescent display device.

U.S. Pat. No. 5,705,284 teaches a thin film electroluminescence device which is characterized in that as a light emitting layer material or charge ‘injection layer material, a polymer film having at least one of a light emitting layer function, a charge transport function and a charge injection function, and having a film thickness of not: more than 0.5 micon is prepared by the vacuum evaporation method and used.

U.S. Pat. No. 5,703,436 teaches a multicolor organic light-emitting device. The LED device employs vertically stacked layers of double hetero-structure devices which are fabricated from organic compounds. The vertical stacked structure is formed on a glass base having a transparent coating of ITO or similar metal to provide a substrate. Deposited on the substrate is the vertical stacked arrangement of three double hetero-structure devices, each fabricated from a suitable organic material. Stacking is implemented such that the double hetero-structure with the longest wavelength is on the top of the stack. This constitutes the device emitting red light on the top with the device having the shortest wavelength, namely, the device emitting blue light, on the bottom of the stack. Located between the red and blue device structures is the green device structure. The devices are configured as stacked to provide a staircase profile whereby each device is separated from the other by a thin transparent conductive contact layer to enable light emanating from each of the devices to pass through the semitransparent contacts and through the lower device structures while further enabling each of the devices to receive a selective bias. The devices are substantially transparent when de-energized, making them useful for heads-up display applications.

U.S. Pat. No. 5,702,643 teaches a ZnS:Cu electroluminescent phosphor which has a halflife of at least about 900 hours. The half-life improvement is made by doping the phosphor with minor amounts of gold and substantially increasing the amount of low intensity milling between firing steps. The phosphor has a dramatically longer halflife without sacrificing brightness or exhibiting large shifts in emission color.

U.S. Pat. No. 5,700,592 teaches an electro-luminescent edge emitting device which has an improved operational life and electroluminescent efficiency includes a host material composed of at least two Group II elements and at least one element selected from Group VIA. The host material is doped with at least one of the rare earth elements in its 3+or 2+oxidation state. Two Group IIB elements may be selected, namely cadmium and zinc. Three Group IIA elements, magnesium, calcium and strontium, may bee selected as the host material. The Group VIA element is sulfide and/or selenide. The dopant is composed of one, two or three elements selected from the rare earth elements (lanthanides). The dopants may include Mn.sup.2+ and one or two of the lanthanides.

U.S. Pat. No. 5,700,591 teaches a phosphor thin film of a compound of zinc, cadmium, manganese or alkaline earth metals and an element of group VI which is sandwiched by barrier layers having a larger energy gap than that of the phosphor thin film, and a plurality of the sandwich structures are accumulated thicknesswise to constitute a light-emitting device. The phosphor thin film ensures the confinement of injected electrons and holes within the phosphor thin film. The light-emitting device has a high brightness and a high efficiency.

U.S. Pat. No. 5,693,962 teaches an organic full color light emitting diode array which includes a plurality of spaced apart, light transmissive electrodes formed on a substrate, a plurality of cavities defined on top of the electrodes and three electroluminescent media designed to emit three different hues deposited in the cavities. A plurality of spaced metallic electrodes arranged orthogonal to the transmissive electrodes and formed to seal each of the cavities, thereby, sealing the electroluminescent media in the cavities, with a light transmissive anodic electrode at the bottom of each cavity and an ambient stable cathodic metallic electrode on the top of each cavity.

U.S. Pat. No. 5,683,823 teaches an electro-luminescent device. The device includes an anode, a positive-hole transporting layer made of an organic compound, a fluorescent-emitting layer made of an organic compound and a cathode. The fluorescent emitting layer includes a red light-emitting material uniformly dispersed in a host emitting material. The host emitting material is adapted to emit in the blue green regions so that the light produced by this device is substantially white.

U.S. Pat. No. 5,677,594 teaches an electro-luminescent phosphor which is sandwiched by a pair of insulating layers which are sandwiched by a pair of electrode layers to provide an AC TFEL device. The phosphor consists of a host material and an activator dopant that is preferably a rare earth. The host material is an alkaline earth sulfide, an alkaline earth selenide or an alkaline earth sulfide selenide that includes a Group 3A metal selected from aluminum, gallium and indium. The phosphor is preferably fabricated by first depositing a layer of the alkaline earth sulfide, alkaline earth selenide or alkaline earth sulfide selenide including the rare earth dopant therein, depositing thereon an overlayer selected from an alkaline earth thiogallate, an alkaline earth thioindate, an alkaline earth thioaluminate, an alkaline earth selenoaluminate, an alkaline earth selenoindate, or an alkaline earth selenogallate. The two layers are annealed at a temperature preferably between 750 and 850 degrees C.

U.S. Pat. No. 5,675,217 teaches a color EL device which includes a substrate, a first electrode formed on the substrate, a first insulating layer formed on the first electrode, a phosphorous layer formed on the first insulating layer and having inserted therein one or more intermediate insulating layers, a second insulating layer formed on the phosphorous layer and a second electrode formed on the second insulating layer.

U.S. Pat. No. 5,672,937 teaches flexible translucent electro-conductive plastic film electrodes which are produced by perforating a normally nonconductive translucent plastic film, and then applying to both surfaces of the film thin layers of a conductive metal oxide such as indium-tin oxide. The conductive layers communicate through the perforations to form an electro-conductive film electrode useful with an electro-luminescent layer and a rear electrode to form lights, signs and similar electro-luminescent laminates.

U.S. Pat. No. 5,670,839 teaches UV light of increased luminous intensity. Layered on one surface of a translucent substrate are a transparent electrode, a first insulating layer, an EL layer, a second insulating layer, and a metal electrode, in that order. A compound of the general formula: Zn.sub.(1−x) Mg.sub.x S is selected as a host material of the EL layer, and Gd or a Gd compound is selected as the luminescence center. The composition ratio x of the compound selected as a host material is selected to be within the range of 0.33.1toreq.x<1, and preferably within the range of from 0.4-0.8, inclusive. This selection allows the band gap energy of the host material to be higher than the band gap energy of the luminescence center, thus preventing the absorption of the emitted light by the host material and providing UV light of increased luminous intensity.

U.S. Pat. No. 5,667,905 teaches a solid-state electro-luminescent device. The device includes a mixed material layer formed of a mixture of silicon and silicon oxide doped with rare earth ions so as to show intense room-temperature photo- and electro-luminescence. The luminescence is due to internal transitions of the rare earth ions. The mixed material layer has an oxygen content ranging from 1 to 65 atomic percent and is produced by vapor deposition and rare earth ions implant. A separated implant with elements of the V or III column of the periodic table of elements gives rise to a PN junction. The so obtained structure is then subjected to thermal treatment in the range 400 to 1100 degrees C.

U.S. Pat. No. 5,663,573 teaches light-emitting bipolar devices. The devices consist of a light-emitter formed from an electro-luminescent organic light-emitting material in contact with an insulating material. The light emitter is in contact with two electrodes that are maintained in spaced apart relation with each other. The light emitter can be formed as an integral mixture of light emitting materials and insulating materials or as separate layers of light-emitting and insulating materials. The devices operate with AC voltage of less than twenty-four volts and in some instances at less than five volts. Under AC driving, the devices produce modulated light output which can be frequency or amplitude modulated. Under DC driving, the devices operate in both forward and reverse bias.

U.S. Pat. No. 5,656,888 teaches a novel thin-film electro-luminescent (TFEL) structure for emitting light in response to the application of an electric field which includes first and second electrode layers sandwiching a TFEL stack, the stack including first and second insulator layers and a phosphor layer that includes an alkaline earth thiogallate doped with oxygen.

U.S. Pat. No. 5,652,067 teaches an organic electro-luminescent device which includes a substrate and formed thereon a multi-layered structure successively having at least an anode layer, an organic electro-luminescent layer and a cathode layer, a sealing layer having at least one compound selected from the group consisting of a metal oxide, a metal fluoride and a metal sulfide is further provided on the electrode layer formed later. A hole injecting and transporting layer is preferably provided between the anode layer and the organic electro-luminescent layer. An electron injecting and transporting layer may also be provided between the organic electro-luminescent layer and the cathode layer. At least one layer of the hole injecting and transporting layer, organic electro-luminescent layer and electron injecting and transporting layer may be formed of a poly-phosphazene compound or a polyether compound or a polyphosphate compound having an aromatic tertiary amine group in its main chain.

U.S. Pat. No. 5,650,692 teaches an electro-luminescent device. The device includes a substrate and an electro-luminescent stack. The stack forms a step relative to the substrate. A transparent layer of protective material is placed atop the stack to bridge the step and create a smooth edge profile along the edge. A metallization layer is situated atop the layer of protective material and is coupled to the electro-luminescent stack through vias in the protective material.

U.S. Pat. No. 5,648,181 teaches an inorganic thin film EL device which includes on an insulating substrate, a back electrode, an insulating layer, a light emission layer, an insulating layer, and a transparent electrode formed on the substrate in this order. The emission layer includes lanthanum fluoride and at least one member selected from the group consisting of rare earth element metals and compounds thereof. The rare earth element is, for example, cerium, praseodymium, neodium, samarium, europium, gadolinium, terbium, dysprosium, holmium, erbium, thulium, ytterbium and mixture thereof. The compounds maybe those compounds of the rare earth elements and fluorine, chlorine, bromine, iodine and oxygen. The rare earth element is preferably present in the emission layer in an amount of from 5 to 90 wt U.S. Pat. No. 5,646,480 teaches an electro-luminescent display panel which has a plurality of parallel metal assist structures deposited on a glass substrate, a plurality of parallel transparent electrodes are deposited over and aligned with the metal assist structures such that each metal assist structure is surrounded by a transparent electrode. A conventional stack of dielectric and phosphor layers and a plurality of metal electrodes is deposited thereon to complete the electro-luminescent display panel.

U.S. Pat. No. 5,645,948 teaches an organic EL device which includes an anode and a cathode, and at least one organic luminescent medium containing a compound of benzazoles of the formula: ##STR1## wherein: n is an integer of from 3 to 8; Z is 0, NR or S; and R and R′ are individually hydrogen; alkyl of from 1 to 24 carbon atoms, for example, propyl, t-butyl, heptyl, and the like; aryl or hetero-atom substituted aryl of from 5 to 20 carbon atoms for example, phenyl and naphthyl, furyl, thienyl, pyridyl, quinolinyl and other heterocyclic systems; or halo such as chloro, fluoro; or atoms necessary to complete a fused aromatic ring; B is a linkage unit consisting of alkyl, aryl, substituted alkyl, or subsituted aryl which conjugately or unconjugately connects the multiple benzazoles together.

U.S. Pat. No. 5,644,327 teaches an electro-luminescent display formed on a ceramic substrate. The substrate has a front ceramic surface and a back ceramic surface. The ceramic substrate includes a metal core that provides structural support, electrical ground, and heat dissipation. Electro-luminescent cells are mounted on the front ceramic surface and driver circuits for driving the electro-luminescent cells are mounted on the back ceramic surface. The driver circuits are positioned directly behind the electro-luminescent cells. Connectors extend through the ceramic substrate and the electro-luminescent cells to different driver circuits. By positioning the driver circuits close to the EL cells, the drive lines from the drivers to the EL cells are short which allows for high refresh rates and low resistance losses. Each of the driver circuits can drive one electro-luminescent cell or a group of electro-luminescent cells. EL display cells coupled to a ceramic electrode can also be driven by a field emission device or a low power electron beam.

U.S. Pat. No. 5,643,829 teaches a multi-layer electro-luminescence device which is formed by the steps of forming a lower electrode with a predetermined pattern on a substrate, forming a first insulation layer on the lower electrode atop the substrate; forming a multiply luminescent layer consisting of CaS and SrS on the first insulation layer at the same temperature with that for the first insulation layer; forming a second insulation film on the luminescent layer-; and forming-an upper electrode with a predetermined on the second insulation layer. In the multiply luminescent layer, a plurality of CaS plies and a plurality of SrS plies are formed in such a way that the CaS plies and the SrS plies alternate with each other and the outmost upper and lower plies are formed of CaS. The constituent substances for the multiply luminescent layer, CaS and SrS, can be deposited at the same temperature and have similar lattice constants which can lead to a matched interface between the CaS and SrS plies. By virtue of these advantages, stresses imposed on the interface, including thermal stress, can be significantly reduced. In addition, the matched interface makes electrons be accelerated with large energy, so that the fabricated multi-layer luminescence device may show good quality.

U.S. Pat. No. 5,643,685 teaches an electro-luminescence element composed of a substrate, a first electrode, a first insulating layer, a light-emitting layer, a second insulating layer, and a second electrode in this order and a process for producing the same are disclosed, in which the light-emitting layer which includes a chemically stable oxide material containing a plurality of elements, the composition ratio of the elements constituting the oxide material being substantially equal to that of the elements charged, the light-emitting layer is formed by coating a first insulating layer with a sol solution containing a plurality of metal elements at a prescribed composition ratio and heating the coating layer to form an oxide layer.

U.S. Pat. No. 5,643,496 teaches an electro-luminescent phosphor composed of copper activated zinc sulfide having an average particle size less than 23 micrometers and a half-life equal to or greater than the half-life of a second phosphor having a similar composition and an average particle size of at least 25 micrometers.

U.S. Pat. No. 5,641,582 teaches a thin-film EL element which does not permit the color of the emitted light to change irrespective of a change in the voltage, which remains chemically stable and which emits light of high brightness even on a low voltage. The element includes two or more poly-crystalline thin light emitting layers and one or more thin insulating layers. The interface between a thin film and a thin film constituting a light emitting layer is formed by epitaxial growth, and the electrical characteristics of the element are equivalent to those of a single circuit which includes two Zener diodes connected in series, a capacitor connected in parallel with the serially connected Zener diodes, and a capacitor connected to one end of the capacitor.

U.S. Pat. No. 5,635,308 teaches phenyl-anthracene derivatives of the formula: A.sub.l --L--A.sub.2 wherein A.sub.l and A.sub.2 each are a monophenylanthryl or diphenylanthryl group and L is a valence bond or a divalent linkage group, typically arylene are novel opto-electronic functional materials. They are used as an organic compound layer of organic EL device, especially a light emitting layer for blue light emission.

U.S. Pat. No. 5,635,307 teaches a thin-film EL element having as a laminated luminescent composite a configuration which includes at least a first layer and a second layer wherein the first layer includes a compound having a lattice constant, before lamination, larger than that of a compound constituting the second layer, and contains manganese as a luminescent center impurity, the difference between the lattice constant, before lamination, of the compound of the first layer and the compound constituting the second layer is 5% or more, and the peak value of the emission spectrum of the laminated luminescent composite rests on 590 nm or more, whereby the thin-film EL element can provide red light having high color purity.

U.S. Pat. No. 5,635,110 teaches a multi-stage process for preparing a phosphor product which includes the stages of selecting precursors of a dopant and a host lattice as the phosphor starting materials, grinding the starting materials in an initial grinding stage for an initial grinding time period to produce an initial ground material having a smaller particle size distribution than the starting materials, firing the initial ground material in an initial firing stage at an initial firing temperature for an initial firing time period to produce an initial fired material, grinding the initial fired material in an intermediate grinding stage for an intermediate grinding time period to produce an intermediate ground material having a smaller particle size than the initial fired material, wherein the intermediate grinding time period is substantially less than the initial grinding time period, firing the intermediate ground material in an intermediate firing stage at an intermediate firing temperature for an intermediate firing time to produce an intermediate fired material, wherein the intermediate firing temperature is substantially greater than the initial firing temperature, grinding the intermediate fired material in a final grinding stage for a final grinding time period to produce a final ground material having a smaller particle size than the intermediate fired material, and firing the final ground material in a final firing stage at a final firing temperature for a final firing time to produce a phosphor product, wherein the final firing time is substantially less than the intermediate firing time.

U.S. Pat. No. 5,625,255 teaches an inorganic thin film EL device which includes a substrate, a pair of % electrode layers and a pair of insulating layers formed on the substrate in this order, and a light emission layer sandwiched between the paired insulating layers and arranged such that light emitted from the light emission layer is taken-out from one side the light emission layer. The light emission layer is made of a composition which consists essentially of a fluoride of a metal of the group II of the Periodic Table and a member selected from the group consisting of rare earth elements and compounds thereof. The metal fluoride is of the formula, M.sub.1−x F.sub.2+y or M.sub.l+x F.sub.2−y, wherein M represents a metal of the group II of the Periodic Table, x is a value ranging from 0.001 to 0.9 and y is a value ranging from 0.001 to 1.8. The device is useful as a flat light source.

U.S. Pat. No. 5,621,069 teaches a technique for the preparation of conjugated arylene and heteroarylene vinylene polymers by thermal conversion of a polymer precursor prepared by reacting an aromatic ring structure with an aqueous solution of an alkyl xanthic acid potassium salt. In this processing sequence the xanthate group acts as a leaving group and permits the formation of a prepolymer which is soluble in common organic solvents. Conversion of the prepolymer is effected at a temperature ranging from 150 to 250 degrees C. in the presence of forming gas. Studies show that electro-luminescent devices prepared in accordance with the described technique evidence internal quantum efficiencies superior to those of the prior art due to the presence of pinhole free films and therefore permit the fabrication of larger area LED's than those prepared by conventional techniques.

U.S. Pat. No. 5,612,591 teaches an electro-luminescent device which includes the sequential lamination of a first electrode, first insulating layer, phosphor layer, second insulating layer and second electrode while using an optically transparent material at least on the side on which light leaves the device; wherein, in. addition to the phosphor layer being composed of calcium thiogallate (CaGa.sub.2 S.sub.4) doped with a luminescent center element, the host of the phosphor layer is strongly oriented to the (400) surface.

U.S. Pat. No. 5,608,287 teaches an electro-luminescent device. The device has a bottom electrode layer disposed on a substrate for injecting electrons into an organic layer, and a top electrode, such as ITO, disposed on the organic layer for injecting holes into the organic layer. The bottom electrode is formed of either metal silicides, such as, rare earth silicides, or metal borides, such as lanthanum boride and chromium boride having a work function of 4.0 eV or less. The electrodes formed from either metal silicates, or metal borides provide protection from atmospheric corrosion.

U.S. Pat. No. 5,640,398 teaches an electro-luminescence light-emitting device for generating an optical wavelength which includes a substrate; an ITO layer coated on the substrate, at lest two light-emitting layers sequentially formed on the ITO layer and having a different band gap, and a metal electrode formed on an upper light-emitting layer of the at least two light-emitting layers. The ITO layer is used as an anode and the metal electrode is used as a cathode.

U.S. Pat. No. 5,598,059 teaches an AC thin film electro-luminescent (TFEL) device which includes a multi-layer phosphor for emitting white light having improved emission intensity in the blue region of the spectrum. The multi-layer stack consists of an inverted structure thin film stack having a red light emitting manganese doped zinc sulfide (ZnS:Mn) layer disposed on a first insulating layer; a blue-green light emitting cerium doped strontium sulfide (SrS:Ce) layer disposed on the red light emitting layer; and a blue light emitting cerium activated thiogallate phosphor (Sr.sub.x Ca.sub.1−x Ga.sub.2 S.sub.4:Ce) layer disposed on the blue-green light emitting layer. The manganese doped zinc sulfide layer acts as a nucleating layer that lowers the threshold voltage, and the cerium activated thiogallate phosphor layer provides a moisture barrier for the hydroscopic cerium doped strontium sulfide layer. The white light from the multi-layer phosphor can be appropriately filtered to produce any desired color.

U.S. Pat. No. 5,593,782 teaches encapsulated electro-luminescent phosphor particles. The particles are encapsulated in a very thin oxide layer to protect them from aging due to moisture intrusion. The particles are encapsulated via a vapor phase hydrolysis reaction of oxide precursor materials at a temperature of between about 25 to about 170 degrees C., preferably between about 100 and about 150 degrees C. The resultant encapsulated particles exhibit a surprising combination of high initial luminescent brightness and high resistance to humidity-accelerated brightness decay.

U.S. Pat. No. 5,578,379 teaches siloxene and siloxene derivatives. These derivatives are compatible with silicon and which may be generated as epitaxial layer on a silicon mono-crystal. This permits the production of novel and advantageous electro-luminescent devices, such as displays, image converters, optical-electric integrated circuits. Siloxene and siloxene derivatives may also be advantageously employed in lasers as laser-active material and in fluorescent lamps or tubes as luminescent material.

U.S. Pat. No. 5,574,332 teaches a low-pressure mercury discharge lamp which includes a luminescent screen. The luminescent screen includes a zeolite containing trivalent Ce. The luminescent screen exhibits a large quantum efficiency for converting W radiation of 254 nm into radiation having an emission maximum at approximately 346 nm.

U.S. Pat. No. 5,561,304 teaches an electro-luminescent silicon device which includes a silicon structure. The structure has a bulk silicon layer- and a porous-silicon layer. The-porous layer has merged pores. The pores define silicon quantum wires. The quantum wires have a surface passivation layer. The porous layer exhibits photoluminescence under ultra-violet irradiation. The porous layer is pervaded by a conductive material such as an electrolyte or a metal. The conductive material ensures that an electrically continuous current path extends through the porous layer; it does not degrade the quantum wire surface passivation sufficiently to render the quantum wires non-luminescent, and it injects minority carriers into the quantum wires. An electrode contacts the conductive material and the bulk silicon layer has an Ohmic contact. When biased the electrode is the anode and the silicon structure is the cathode. Electro-luminescence is then observed in the visible region of the spectrum.

U.S. Pat. No. 5,554,911 teaches a multi-color light-emitting element which has at least two optical micro-cavity structures having respectively different optical lengths determining their emission wavelengths. Each micro-cavity structure contains a film of or organic material as a light-emitting region, which may be a single film of uniform thickness in the element.

U.S. Pat. No. 5,554,449 teaches a high luminance thin-film electro-luminescent device which includes a phosphor layer having SrS as the host material and a luminous center. The phosphor layer is sandwiched between two insulating layers and two thin-film electrodes are provided on each side of the insulating layers. At least one of the electrodes is transparent, and the excitation spectrum of the phosphor layer exhibits a peak having a maximum value at a wavelength of about from 350 nm to 370 nm. Such a high luminance thin-film electroluminescent device can be prepared by annealing its phosphor layer having SrS as the host material at a temperature of at least 650 degrees C. for at least one hour in an atmosphere of a sulfur-containing gas.

U.S. Pat. No. 5,543,237 teaches an inorganic thin film EL device which includes, on an insulating substrate, a back electrode, an insulating layer, a light emission layer, an insulating layer and a transparent electrode formed on the substrate in this order. The emission layer includes a fluoride of an alkaline earth metal and at least one member selected from the group consisting of rare earth element metals and compounds thereof at a mixing ratio by weight of 10:90 to 95:5. The rare earth element is, for example, cerium, praseodymium, neodymium, samarium, europium, gadolinium, terbium, dysprosium, holmium, erbium, thulium, ytterbium and mixture thereof. The compounds may be those compounds of the rare earth elements and fluorine, chlorine, bromine, iodine and oxygen.

U.S. Pat. No. 5,541,012 teaches a new infrared-to-visible up-conversion material which can be applied to an infrared light identification element having a useful conversion efficiency and sensitivity for infrared light in the wavelength of 1.5 micron band, 0.98 micron band and 0.8 micron band without the necessity of previous excitation of the material. This infrared-to-visible up-conversion material consists of an inorganic material comprising at least two elements of erbium (Er) and a halogen or compounds thereof.

U.S. Pat. No. 5,540,999 teaches an electro-luminescent element. The element includes an organic compound layer formed of a thiophene polymer as a light emitting layer or a hole-injection transport layer. The element emits light at high luminance and is reliable.

U.S. Pat. No. 5,536,588 teaches an amorphous organic thin-film element containing dye molecules with .SIGMA..DELTA.Str,m (J/(K.kmol))/Mw of 60 or less, assuming that the molecular weight is Mw and the sum total of an entropy change of melting and entropy changes of transition from a glass transition point to a melting point is .SIGMA..DELTA.Str,m (J/(K.kmol)), and having a high heat resistance and a high stability over long periods of time.

U.S. Pat. No. 5,529,853 teaches an organic EL element which includes a hole-injecting electrode and an electron-injecting electrode, and at least a film made of a luminous material there-between. The luminous material is one of a metal complex polymer, an inner complex salt having two or more ligands, and 10-hydroxybenzo [h] quinoline-metal complex.

U.S. Pat. No. 5,521,465 teaches an AC thin film electro-luminescent display panel includes a metal assist structure formed on and in electrical contact over each transparent electrode and light absorbing darkened rear electrodes. The electrodes combine to provide a sunlight viewable display panel.

U.S. Pat. No. 5,517,080 teaches an AC thin film electro-luminescent display panel includes a metal assist structure formed on and in electrical contact over each transparent electrode, and a graded layer of light absorbing dark material which combine to provide a sunlight viewable display panel.

U.S. Pat. No. 5,516,577 teaches an organic electro-luminescence device which includes laminating layers in the order of anode/light emitting layer/adhesive layer/cathode, or anode/hole-injecting layer/light emitting layer/adhesive layer/cathode, the energy gap of the light emitting layer being larger than that of 8-hydroxyquinoline or metal complex thereof and contained in the adhesive layer, the light emitting layer comprising a compound which emits a blue, greenish blue or bluish green light in CIE chromaticity coordinates, and the adhesive layer including a metal complex of 8-hydroxyquinoline or a derivative thereof and at least one organic compound in an arbitrary region in the—direction of the thickness of the layer, the thickness of which is smaller than that of the above-mentioned light emitting layer. According to the above organic electro-luminescence device, improvements in uniformity in light emission and emission efficiency are realized.

U.S. Pat. No. 5,508,585 teaches an EL lamp includes a transparent electrode, an electro-luminescent dielectric layer overlying the transparent electrode, a patterned insulating layer overlies selected portions of the dielectric layer for reducing the electric field across the selected portions of the electro-luminescent dielectric layer, and a rear electrode overlying the insulating layer and the electro-luminescent dielectric layer. The insulating layer is preferably a low dielectric constant material and can overlie the electro-luminescent dielectric layer or can be located between a separate dielectric layer and a phosphor layer. A gray scale is produced by depositing or printing more than one thickness of insulating layer.

U.S. Pat. No. 5,500,568 teaches an organic EL device having, as a cathode, a vapor deposited film containing at least one metal A selected from Pb, Sn and Bi and a metal B having a work function of 4.2 eV or less has high chemical stability of the cathode with time and high power conversion efficiency, and is useful as a display device and a light-emitting device.

U.S. Pat. No. 5,491,377 teaches a flexible, thick film, electro-luminescent lamp in which a single non-hygroscopic binder is used for all layers (with the optional exception of the rear electrode) thereby reducing delamination as a result of temperature changes and the susceptibility to moisture. The binder includes a fluoro-polymer resin, namely poly-vinylidene fluoride, which has ultraviolet radiation absorbing characteristics. The use of a common binder for both phosphor and adjacent dielectric layers reduces lamp failure due to localized heating, thus increasing light output for a given voltage and excitation frequency, and increasing the ability of the lamp to withstand over-voltage conditions without failure. The lamps may be made by screen-printing, by spraying, by roller coating or vacuum deposition, although screen printing is preferred. By the multi-layer process, unique control of the illumination is achieved.

U.S. Pat. No. 5,487,953 teaches an organic electro-luminescent device which includes an organic emitting layer and a hole-transport layer laminated with each other and arranged between a cathode and an anode, in characterized in that the hole transport layer made of the triphenylbenzene derivative. This hole-transport layer has the high heart-resistant property and high conductivity to improve the durability and thus this device emits light at a high luminance and a high efficiency upon application of a low voltage.

U.S. Pat. No. 5,484,922 teaches an organic electro-luminescent device which employs, an aluminum chelate of the formula: wherein n is 1 and x is 1 or 2, or n is 2 and x is 1; and, Q is a substituted 8-quinolinolato group in which the 2-position substituent is selected from the group consisting of hydrocarbon groups containing from 1 to 10 carbon atoms, amino, aryloxy and alkoxy groups; L is a ligand, each L ligand being individually selected from (a) the group consisting of —R, —Ar, —OR, —ORAr, —OAr, —OC(O)R, —OC(O)Ar, —OP(O)R.sub.2, —OP(O)Ar.sub.2, —OS(O.sub.2)R, —OS(O.sub.2)Ar, —SAr, —SeAr, —TeAr, —OSiR.sub.3, —OSiAr.sub.3, —OB(OR).sub.2, —OB(OAr).sub.2, and —X, when x is 1, or from (b) —OC(O)Ar′C(O)O— or —OAr′O—, when x is 2, where R is a hydrocarbon group containing from 1 to 6 carbon atoms, Ar and Ar′ are, respectively, monovalent and divalent aromatic groups containing up to 36 carbon atoms each, and X is a halogen; with the proviso that when L is a phenolic group n is 2 and x is 1.

U.S. Pat. No. 5,456,988 teaches an electro-luminescent device having a hole injection electrode, an electron injection electrode, and at least an organic emitting layer there-between. The organic emitting layer includes an 8-quinolinol derivative-metal complex whose ligand is selected from the group consisting of chemical formulas 102 through 106: chemical formula 102 ##STR1## chemical formula 103 ##STR2## chemical formula 104 ##STR3## chemical formula 105 ##STR4## chemical formula 106 ##STR5##.

U.S. Pat. No. 5,453,661 teaches a flat panel display which includes a ferro-electric thin film between the first and second spaced apart electrodes. The ferro-electric thin film emits electrons upon application of a predetermined voltage between the first and second spaced apart electrodes. The electrons are emitted in an electron emission path and impinge upon a luminescent layer such as a phosphor layer, which produces luminescence upon impingement upon the emitter electrodes. The ferro-electric thin film is preferably about 2 microns or less in thickness and is preferably a polycrystalline ferro-electric thin film. More preferably, the thin ferro-electric film is a highly oriented, polycrystalline thin ferro-electric film. Most preferably, highly oriented ferro-electric thin film has a preferred (001) crystal orientation and is about 2 microns or less in thickness. A flat panel display may be formed of arrays of such display elements. Top and bottom electrodes or side electrodes may be used. The display may be formed using conventional microelectronic fabrication steps.

U.S. Pat. No. 5,449,564 teaches an EL element which has at least one layer made from an organic material between an electron injection electrode and a hole injection electrode. The organic material consists of an oxadiazole series compound. The compound has a plurality of oxadiazole rings. Each oxadiazole ring is substituted by a condensed polycyclic aromatic group.

U.S. Pat. No. 5,444,268 teaches a thin film EL device.

U.S. Pat. No. 5,443,922 teaches an organic thin film electro-luminescence element.

U.S. Pat. No. 5,443,921 teaches a thin film electro-luminescence device.

U.S. Pat. No. 5,442,254 teaches a fluorescent device with a quantum contained particle screen.

U.S. Pat. No. 5,432,014 teaches an organic electro-luminescent element.

U.S. Pat. No. 5,429,884 teaches an organic electro-luminescent element.

U.S. Pat. No. 5,405,710 teaches an article including micro-cavity light sources.

U.S. Pat. No. 5,404,075 teaches a TFEL element with a tantalum oxide and a tungsten oxide-insulating layer.

U.S. Pat. No. 5,400,047 teaches a high brightness thin film electro-luminescent display with low OHM electrodes.

U.S. Pat. No. 5,382,477 teaches an organic electro-luminescent element.

U.S. Pat. No. 5,374,489 teaches an organic electro-luminescent device.

U.S. Pat. No. 5,336,546 teaches an organic electro-luminescence device.

U.S. Pat. No. 5,328,808 teaches an edge emission type electro-luminescent device arrays.

U.S. Pat. No. 5,320,913 teaches conductive film and low reflection conductive film.

U.S. Pat. No. 5,319,282 teaches a planar fluorescent and electro-luminescent lamp having one or more chambers.

U.S. Pat. No. 5,314,759 teaches a phosphor layer of an electro-luminescent component.

U.S. Pat. No. 5,311,035 teaches a thin film electro-luminescence element.

U.S. Pat. No. 5,309,071 teaches zinc sulfide electro-luminescent phosphor particles and electro-luminescent lamp made therefrom.

U.S. Pat. No. 5,309,070 teaches a TFEL device having blue light emitting thiogallate phosphor.

U.S. Pat. No. 5,306,572 teaches EL element which has an organic thin film.

U.S. Pat. No. 5,300,858 teaches a transparent electro-conductive film, an AC powder type EL panel and a liquid crystal display using the same.

U.S. Pat. No. 2,445,692 teaches an ultraviolet lamp.

U.S. Pat. No. 2,295,626 teaches an ultraviolet lamp.

U.S. Pat. No. 3,845,343 teaches a bulb for an ultraviolet lamp.

The inventor hereby incorporates the above patents by reference.

### SUMMARY OF THE INVENTION

The present invention is directed to a biochip which has a sensor.

In a first aspect of the invention the sensor contains a light source and an optical detector.

In a second aspect of the invention the light source is an electro-luminescent material.

Other aspects and many of the attendant advantages will be more readily appreciated as the same becomes better understood by reference to the following detailed description and considered in connection with the accompanying drawing in which like reference symbols designate like parts throughout the figures.

The features of the present invention which are believed to be novel are set forth with particularity in the appended claims.

### DESCRIPTION OF THE DRAWINGS

FIG. 1 is a schematic drawing of a 1.0″×1.0″ optical array of 90 dye doped porous silica microspheres. Represented are three fluorescent dyes: fluorescein, coumarin, and rhodamine-B. Viewed under 365 nm W excitation.

FIG. 2 is a schematic representation of a multiple dye doped porous silica microsphere for sensing applications. Microsphere diameters range from 500 nm to 2.0 mm, with pore diameters ranging from 1.7 nm to 100 nm.

FIG. 3 is a schematic drawing of three fluorescent dye doped porous silica microsphere sensors with 365 nm excitation (up through large diameter plastic waveguide).

FIG. 4 is an example of a multi-microsphere sensor employing hexavalent urania doped porous silica.

FIG. 5 is a schematic drawing of the ratio (525 nm/475 nm) of fluorescent emission of fluorescein doped porous silica microspheres excited at 365 nm. Equilibrium time approximately 2 minutes.

FIG. 6 is schematic drawing of an example of a single sensor element from a MEMs based sensor array using porous, dye/protein doped silica microspheres.

FIG. 7 through FIG. 22 are schematic drawings of alternative designs including one design which involves “V” shaped troughs with the EL material on one face and the silicon based photodetector on the other with dye-doped and optically active protein doped porous gel microspheres filling the trough.

### DESCRIPTION OF THE PREFERRED EMBODIMENT

U.S. Pat. No. 5,496,997 (Mar. 5, 1996) teaches a sensor which incorporates an optical fiber and a solid porous inorganic microsphere and an optical fiber which having a proximal end and a distal end. The distal end of the optical fiber is coupled to the porous microsphere by an adhesive material. The porous microsphere is doped with a dopant. The dopant may be either an organic dye or an inorganic ion. A sensing apparatus includes the sensor, a spectrophotometer and a source of light. The spectrophotometer is coupled to the proximal end of the optical fiber. The source of light causes either the organic dye or the inorganic ion to fluoresce.

Tremendous progress has been made in recent years in understanding some of the fundamental aspects of chemical and biological sensing. Most research and commercialization efforts have been focused upon fabricating individual sensors for specific and usually narrow applications and application environments. An excellent overview of the subject emphasizing both the challenges and commercial opportunities is given by Weetal [1]. Inasmuch as most commercially available chemical and biological sensors were developed independently of one another, trying to integrate them into one device would be extremely difficult and costly. The challenge of integration rests primarily on developing a multifuctional “platform” sensing technology that can allow the high volume, low cost fabrication of large numbers of individual sensors on a single array. Just as an image on a view screen is composed of a large number of light generating pixels, a sensor array would also be composed of a large number of “sensels”, individual sensor elements to generate an “image” or map of an unknown substance, be it liquid or vapor, being examined. Emphasis needs to be given to the types of platform approaches that have the greatest likelihood of supporting broad based sensing capabilities. Traditional gas sensor technologies, as an example, offer little hope of this type of broad sensing capability [2].

This is not a comprehensive review, but an overview of some of the most exciting recent developments made by researchers in the field that point to an approach that could provide a broad based sensing platform. It also sets the stage for our proposed sensor technology, MEMOSA, which stands for MEMs based Optical Sensor Array. Through the merging of technologies and resources from both MATECH and several university and industry collaborators, highly sophisticated, commercially viable sensor systems could be practical within only a few years.

Integrated sensor arrays permit a single platform for a wide range of simultaneous sensing operations to be conducted. Both optically and electronically based array systems are possible and have been recently demonstrated. In an early example, light to be measured from an unknown source can be passed through a diffraction grating and on to an array of sensors [3]. In this manner, solid-state spectrophomoters using optical fibers to conduct the light from an unknown source can be constructed. By incorporating the chemically and/or biologically active components on to a array of photodiodes and/or electrodes, more sophisticated sensor arrays can be fabricated. Three examples of integrated sensor arrays are highlighted in this section.

Rapidly and accurately detecting fragments of DNA is critically important for the clinical diagnosis of a wide range of genetically predetermined disease states. By detecting the genetic markers of diseases before they become outwardly manifest, allows early intervention and treatment. DNA markers can also signal the initial metastasis of a wide number of cancers. Current hybridization methods typically require high sample DNA concentration for accurate analyses [4]. In vitro amplification technologies, such as PCR require lengthy assay times in order to overcome this problem. Several researchers have pioneered novel approaches to achieve rapid and highly sensitive DNA 8 detection. Ferguson and co-workers have demonstrated a fiber-optic DNA biosensor array with a bundle of seven (7) fibers in a small probe [4]. The only significant drawback is that labelled sample targets were required [4]. Affymetrix (Santa Clara, Calif.) has recently demonstrated a DNA chip with 12,224 different oligonucleotide probes [5,6]. A key drawback to their technology is that “the chips only read what they are designed to read—you have to know a reference sequence beforehand to design probes to detect variations in that sequence” [5]. Research is also focused on designing better optical probes [7-9]. Recent research at the Public Health Research Institute has shown that using “hairpin shaped oligonucleotide probes” greatly enhances specificity [6]. As originally predicted by Leroy Hood and co-workers in 1988, the tremendous progress in deciphering the human genome, coupled with advances in diagnostic technology could result in a revolutionary advance in disease detection and diagnosis [10].

Another sensor array area which has shown great commercial promise just recently is the effort to develop an “artificial nose”. The science of how we smell is extremely complex [11]. Recent progress has been achieved in mapping how the olfactory system operates [12]. In a recent movie, “Richie Rich”, a comedy shows research scientists developing a hand held device called the SMELL MASTER 2000, which can discriminate between a fine merlot and a cheap jug wine! Unfortunately, the technological challenges make that kind of sensitivity still a fantasy. A recent effort to model a sensor system after the vertebrate olfactory system has been demonstrated by Dickenson, et al. [13]. They use a multitude of dye doped polymers at the end of optical fibers to form a fluorescent response pattern to specific analytes. By employing a distributed sensing approach, they must “train” a neural network for specific vapor recognition [13]. Once they have a pattern or signature for each compound, then the “sniffer” can recognize it if it “smells” it again. One of the drawbacks of this approach is trying to discriminate between complex mixtures of vapors. Another similar approach, but using the electrical properties of an array of 16 carbon black doped porous polymers is being pursued by Cyranno Sciences (Pasadena, Calif.). Their patented technology, licensed from CALTECH, permits a 3-dimentional odor map to be created based upon the response of the sensor array for a wide variety of “smells”[14]. Instead of trying to analyze the constituent components of an odor, they focus upon its overall or composite smell. In this manner, they may actually be able to distinguish between a cabernet and a merlot! But I'd rather do that job myself.

Optical sensor arrays can be fabricated by coupling an array of dye/protein doped microspheres to individual optical optical fibers which can be multiplexed into a spectrophotometer. Linear arrays of optical fibers are now commercially employed in DNA sequence detectors and fluorescence based microtiter plate readers used for ELISA tests in clinical diagnostics. An example of a linear array of optical fibers appears in the Perkin Elmer Applied Biosystems 7700 DNA sequence Analyzer (Foster City, Calif.). The approach can be augmented by the attachment of fluorescence based sensors in the form of microspheres, doped with chemically or biologically active reporter molecules (see sections 5.2 and 5.3).

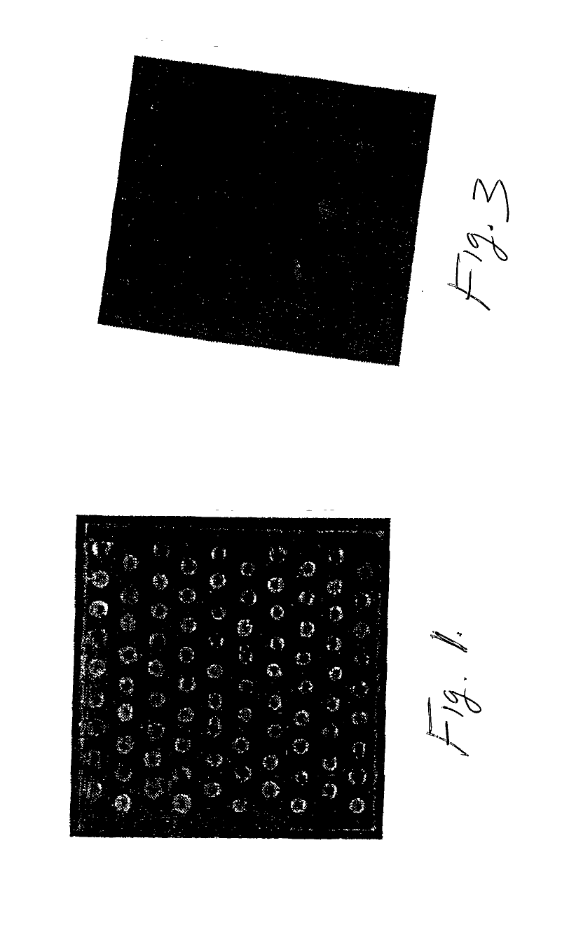

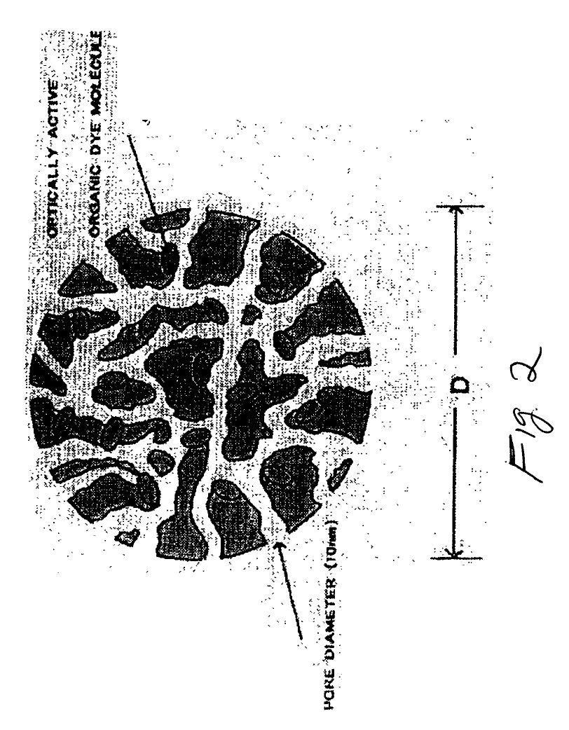

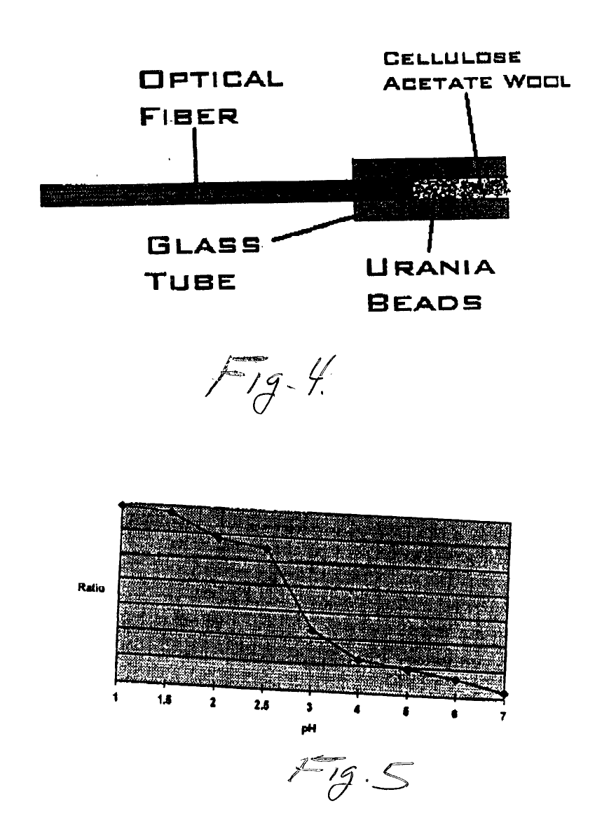

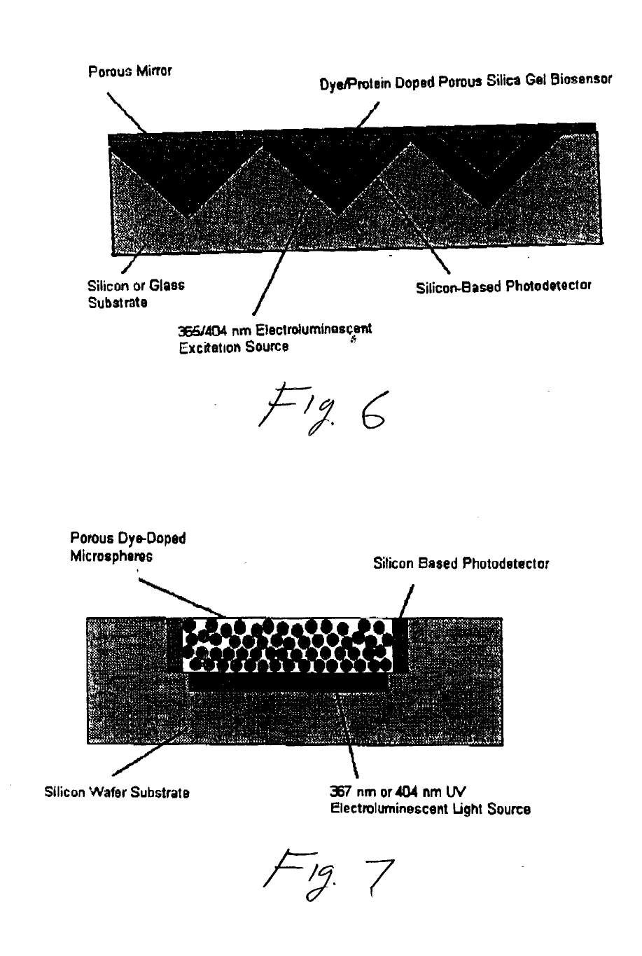

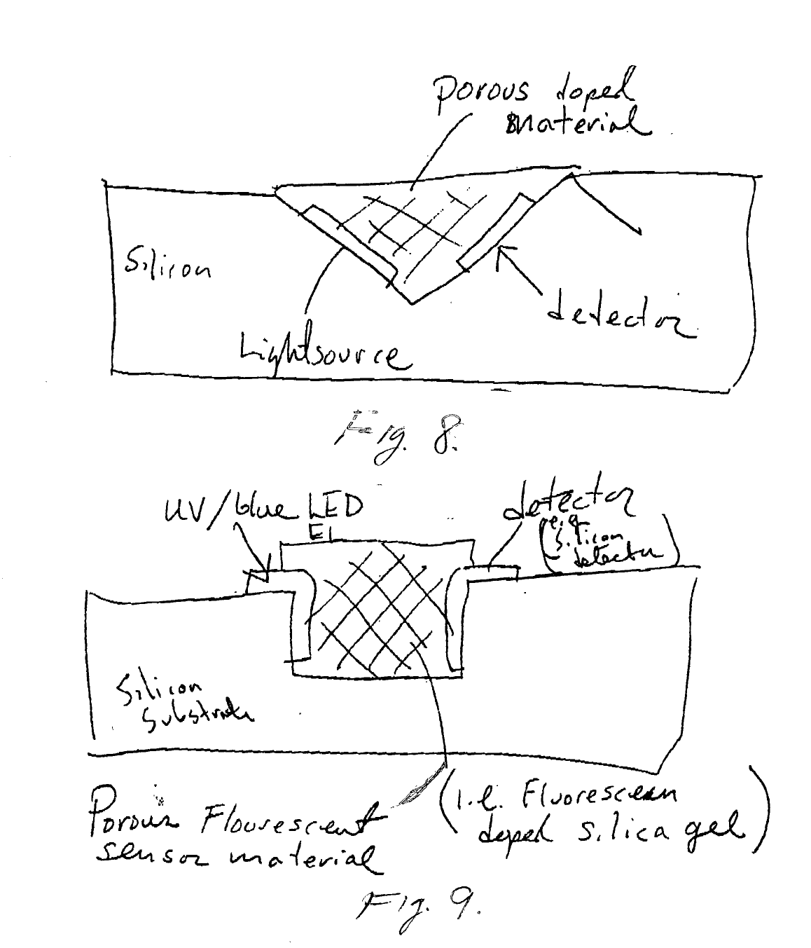

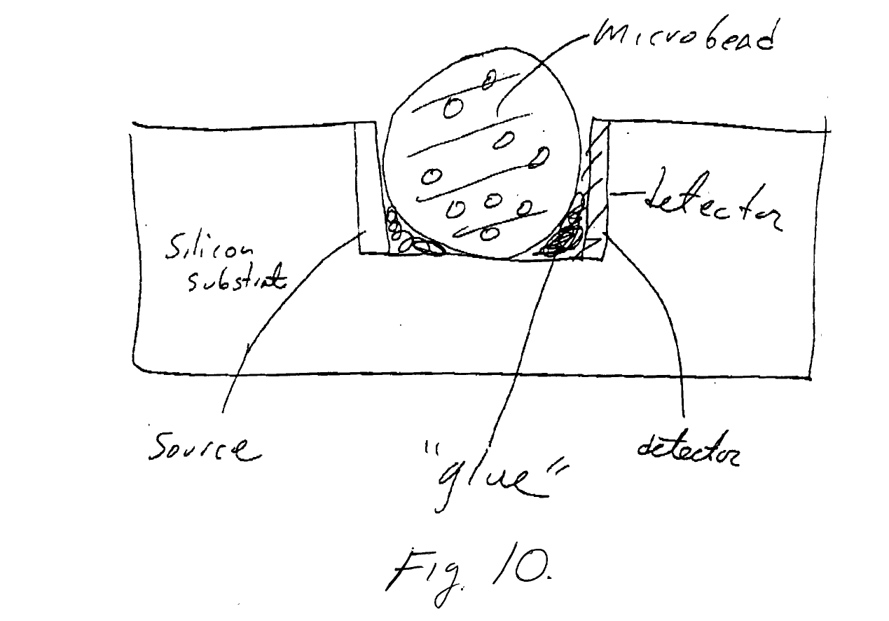

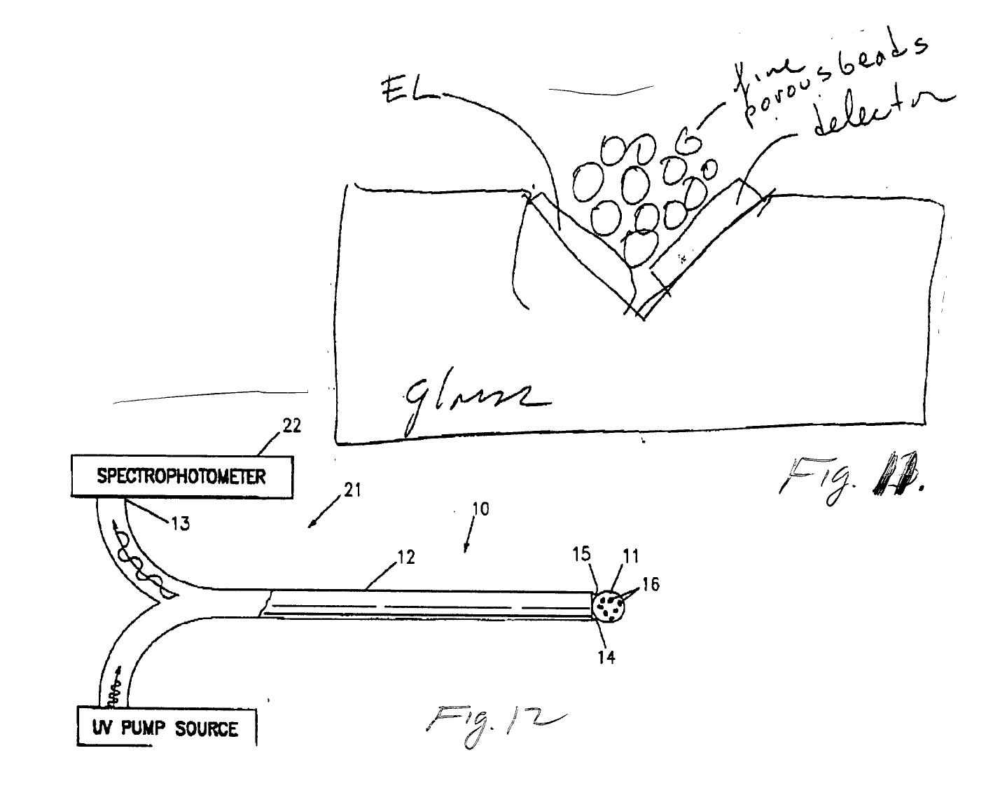

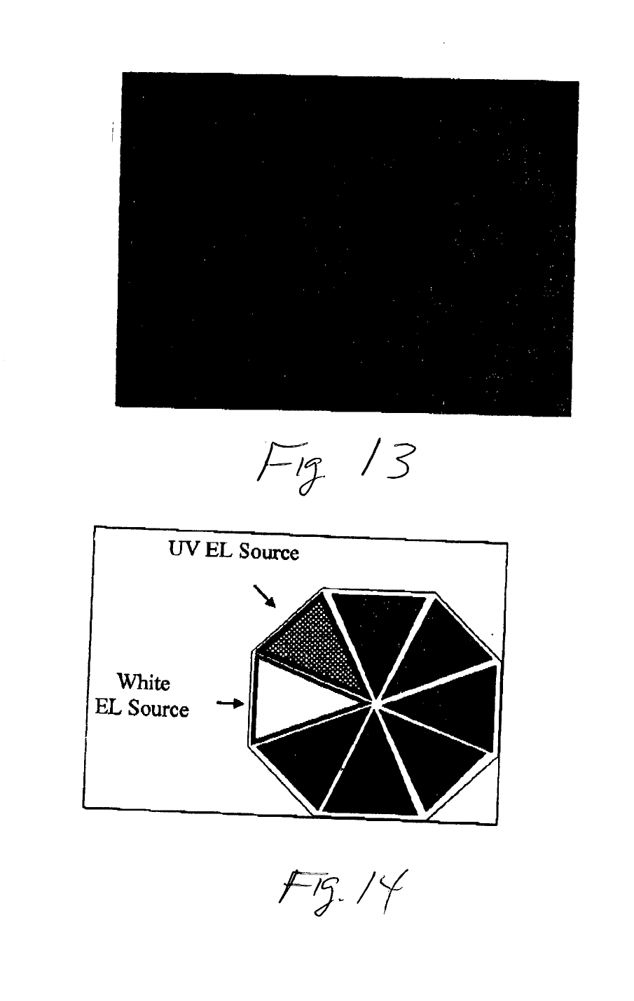

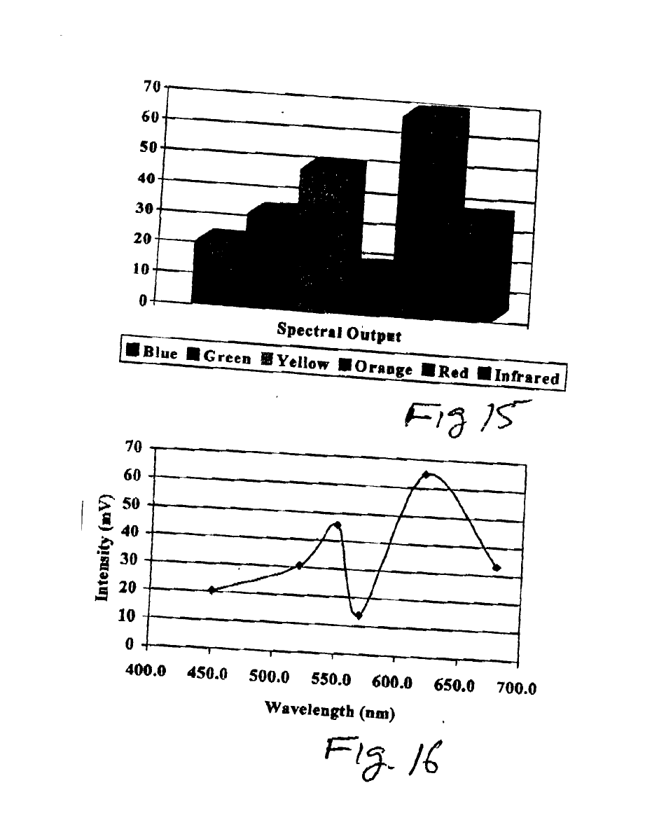

Referring to FIG. 1 a two dimensional array of 90 porous, dye-doped silica microspheres in which three types of dye-doped spheres are alternated in a repeated pattern.

For any sensor array system, pattern recognition protocols are critical. In the two previous examples, DNA sensors and the artificial nose, data from the sensor arrays must be analyzed to “interpret” the pattern of signal from the individual sensor cells that make up the total array. This “intelligence” is not unlike that required for pattern recognition systems currently used for both military, law enforcement and commercial systems designed to recognize shape or morphology, such as the profile of a tank, the unique pattern of a fingerprint, or the shape and size of potato. Behind the architecture of data collection must reside a logic-software to maximize the efficiency of pattern recognition. Usually, these logic loops are hierarchical in nature [15].

A simple example, taking from everyday life, is how one recognizes his mom's sport utility vehicle (SUV). Both his parents and he live in the same town, so he is accustomed to seeing them periodically while driving. It takes only a split second to complete the five step process (were it otherwise he might run into someone). First, he notices the shape (a typical SUV). Then the color (black). Third, he looks for a spare tire attached to the back (there shouldn't be one). Next come the door handles (the back door handles should be on the side of the rear window). Finally, he looks to recognize the occupants (his mom and his dad?). By truncating my analysis at one of the earlier steps, he can shorten the time required to rule-out the suspect vehicle as belonging to his parents. If he closely studies the occupant of every car on the road, he surely be a public menace! Having well designed logic loops for screening while using a sensor array can accelerate the speed of operation of sensor systems. Integrating the sensing system with data collection and interpretation (i.e. software) is necessary for an efficient sensor system.

Fiber-optic sensing has emerged in recent years as a powerful tool for the development of “smart systems”. Applications include medical diagnostics, environmental testing, and industrial monitoring. Optical fibers can be deployed across large distances, often to remote locations which are difficult or impossible to access by other means. Fibers can be used for medical biopsies of the human body, sent down wells, mine shafts, or to the bottom of lakes, rivers and streams. To date, however, fiber-optic sensing has been limited to only few narrowly defined applications. In order to fully exploit the potential of optical fibers for sensing applications, a new, more versatile platform technology is needed.

Jane and Pinchuk teach a method of fabricated fiber-optic chemical sensors using charged hydrogel matrices for the immobilization of calorimetric indicators for the measurement of pH and other applications [16]. Using the phenomenon of thermo-luminescence, Kera, et al teach the method of high temperature flame detection and monitoring employing lanthanide doped optical fibers [17]. Grey et al have shown a system based upon dual fiber optic cells for serum analysis [18]. Wixom teaches a method of shock detection based upon electroluminescent optical fibers [19]. Kane has demonstrated measuring both blood pH and oxygen levels using fiber optic probes [20]. Fiber optic carbon dioxide sensors have been developed for monitoring fermentation processes [21]. Immunosensors based upon enhanced chemoluminescence and fiber optics have also been demonstrated [22].

Employing the sol-gel route, porous glass microspheres, doped with a wide range of optically-active organic and inorganic molecules have been demonstrated [23,24]. It has also been demonstrated that a glass microsphere can be mounted to the end of an optical fiber as a lens [25]. By attaching a dye-doped porous microsphere to the end of an optical fiber, a versatile new sensor system has been developed [26,27]. More about these new sensors is described in the following section.

An alternative approach, pursued by most researchers in the field, is using gel encapsulation to immobilize dyes, proteins, enzymes, and antibodies as part of a thin cladding on a length of the optical fiber [28-30]. This relies upon the evanescent field effect, thereby requiring a certain length of fiber for sensing to be sensitive. Advantages of this method include fast response time. A major disadvantage is that a significant length of fiber is usually needed (at least a few cms) for sensitivity. Others have examined using a small “monolith” of gel encapsulated material at the end of an optical fiber [31]. The potential for using high surface area gel encapsulated antibodies has not been realized inasmuch as the typical pore sizes of silica gels is smaller than the size of the pathogens being detected. Nonetheless, Ligler and collegues have demonstrated, by conjugating antibodies to the outer surface of an optical fiber, that this type of biosensing has great potential utility [32]. The encapsulating of antibodies in a host of high pore volume and large surface area might result in much greater sensitivity. Materials potentially suitable for such an application are described in the following section.

Unlike traditional glass and ceramic processing methods, in which powdered oxides are heated to high temperatures, the sol-gel process permits the fabrication of inorganic gels at temperatures near ambient from liquid solutions [33]. Avnir and co-workers were the first to demonstrate the possibility of incorporating optically-active organic dye molecules into porous gels [34]. More recently, MacCraith and co-workers have successfully demonstrated the possibility of fiber-optic sensing through the application of dye-doped porous silica films to the end of optical waveguides [35,36]. Their sensors take advantage of evanescent wave interactions, such as evanescent wave absorption and evanescent wave excitation of fluorescence [35].

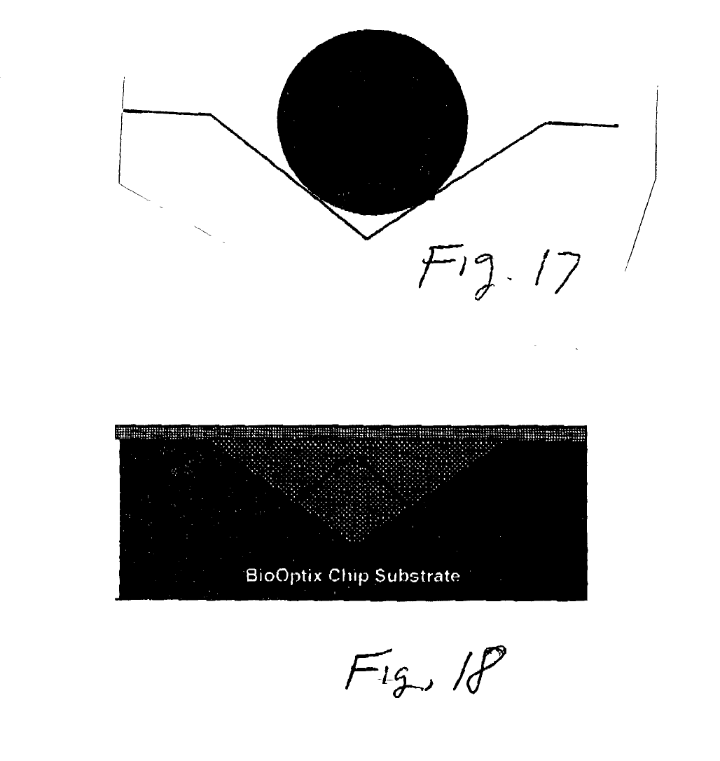

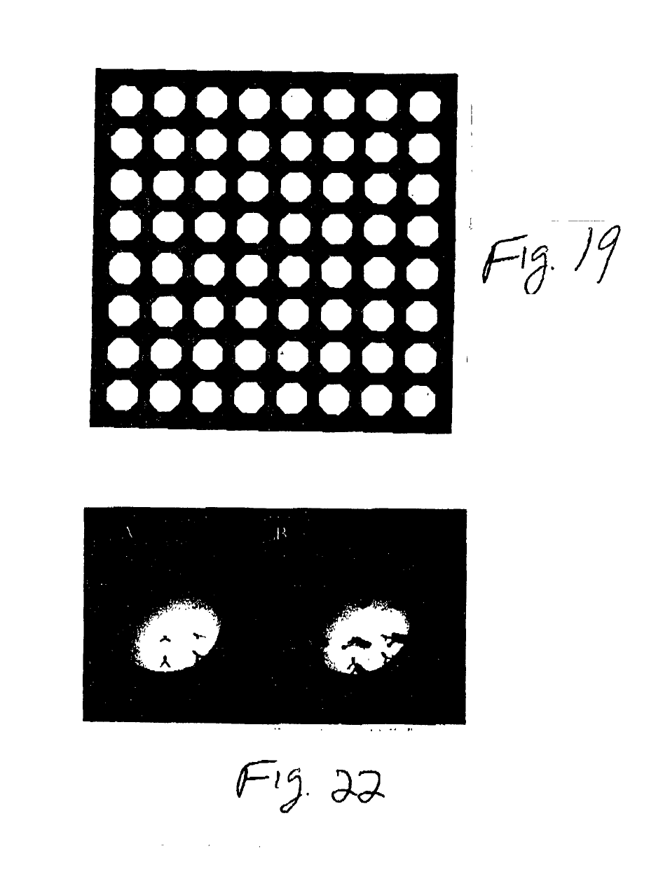

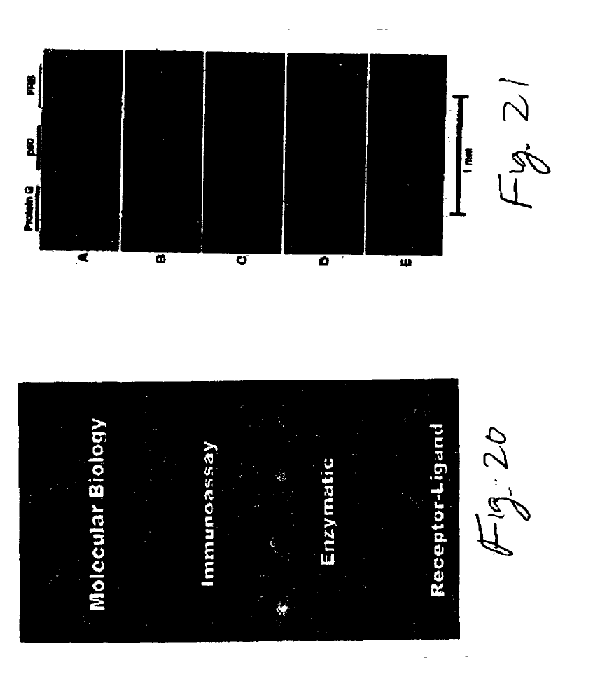

Referring to FIG. 2 dye-doped porous silica microspheres have been prepared from liquid solutions [37]. A wide range of optically-active dopants have been incorporated into silica microspheres, including both organic and inorganic species [37]. Luminescent microspheres have previously been demonstrated for flat-panel display applications [38-40]. The incorporation of dye-doped porous silica microspheres into a fiber-based sensing system has been demonstrated by attaching a porous, dye or protein doped microsphere to the distal end of an optical fiber [26,27]. Ultraviolet or blue light can be utilized to excite fluorescence of the optically-active dye molecule.

Referring to FIG. 3 in conjunction with FIG. 4 three microspheres, doped with fluorescein, coumarin, and rhodamine-B, are shown each attached to an optical fiber in under UV excitation. A wide range of prototype sensors based upon multiple doped microspheres have been developed.

MATECH announced the availability of a series of new, highly porous silica supports for liquid chromatography, catalysis, biosensing, and protein separation applications. MATECH's range of large pore materials represent the first commercial availability of porous silica that possesses both large pore diameters and large pore volumes, attributes critical to large protein and monoclonal antibody separations, for example. While preserving high pore volumes, MATECH's new line of materials have pore sizes ranging from 1.7 to 100 nanometers (17-1000 angstroms).A complete list of MATECH's new line of materials is listed below.

MATERIAL

TYPE PORE SIZE

(Angstroms) SURFACE AREA

(m2/gm) PORE VOLUME

(cc/gm)

| | | | |
|---|---|---|---|
| A | 17 | 400 | 0.3 |
| B | 100 | 500 | 0.7 |
| C | 160 | 900 | 2.2-3.0 |
| D | 250 | 1100 | 2.2-3.0 |
| E | 500 | 450 | 2.0-3.0 |
| F | 1000 | 400 | 1.5-2.0 |

Lucan and co-workers have demonstrated the use of fluorescein dye in sol-gel thin films for possible pH measurement applications [41]. In their work, changes in the absorption spectra of the fluorescein dye molecule after immersion in aqueous solutions of various pH values were measured. Repeat cycles were demonstrated. More recently, evanescent excitation of fluorescein emission in a doped thin film clad region of a 7 meter optical fiber pH sensor has been shown [42].

In the inventor's previously published work, fluorescein-doped porous silica microspheres were immersed in aqueous solutions of various pH values[26]. The fluorescence emission, after a few minutes of immersion, was measured. A significant variation in the fluorescent emission, particularly for pH values between 1 and 7, were observed.

Referring to FIG. 5 the change in the ratio of fluorescence emission at 475 and 525 nm is plotted vs. pH value.

The use of 8-hydroxy-1,3,6-pyrenetrisulfonic acid trisodium salt, “pyranine”, as a sensitive molecular probe for measuring alcohol content of gels has been demonstrated [43,44]. More recently, the staining of microorganisms with pyranine dye prior to gel encapsulation as a biological probe has been performed on S. cerevisiae to monitor ethanol evolution during fermentation [45,46]. Pyranine readily exists in a protonated and deprotonated state. The protonated pyranine fluoresces at 430 nm and the deprotonated pyranine fluoresces at 515 nm. Initially, the pyranine in dried silica gel is fully protonated. After immersion in 0.1 M NH4OH solution, pyranine becomes fully deprotonated. Switching protonation states has been demonstrated to be fully reversible. By immersing pyranine-doped silica microspheres in solutions of ethanol and buffered water of varying alcohol contents, the ratio of protonated to deprotonated fluorescence could be obtained and plotted [26].

It is well known that the fluorescence behavior of organic dye molecules is sensitive to temperature effects in solution, particularly for dye laser applications [47]. Organic dyes, when incorporated into solid-state hosts, should be expected to exhibit similar effects. The fluorescence emission of fluorescein-doped silica microspheres, measured at 0 C and 75 C has been previously published [48]. Using organic dyes, a sensitive fiber-optic thermometer should be possible for temperatures near ambient. In recent unpublished work, the temperature dependence of the fluorescent emission of hexavalent uranium oxide doped silica gel beads or melt glass beads could provide sensitive, optical temperature measurement capabilities up to approximately 800° C.

The ability to detect even trace quantities of heavy metals is of increasing importance for environmental testing. It has long been known that heavy metals, such as lead, form highly stable organometallic compounds [49]. Mackenzie and co-workers have recently shown that organic molecules incorporated into gels and ORMOSILs can bond with heavy metals, such as lead and hexavalent chromium, contained in liquid solutions [50].

By doping silica gel with malachite green, Wong and Mackenzie were able to measure hexavalent chromium in aqueous solutions down to ˜50 ppb [51]. The primary mechanism of detection is based upon changes in the absorption spectra of malachite green. By co-doping with a fluorescent dye molecule, selected for an overlap between the peak absorption of malchite green and the fluorescence peak position of the luminescent dye molecule, it should be possible to construct a fluorescence-based microsensor, as well.

Malachite green is readily soluble in various silica microsphere forming solutions [26]. In previously published work, it has been shown that two prominent peaks in the visible region of the absorption spectra are apparent, at 425 nm and 618 nm [26]. Moreover, it was shown that the ratio of these peaks changes with exposure to hexavalent chromium. By plotting the ratio of these peaks vs. Cr concentration, a sensitive measurement system for Cr content has been recently demonstrated.

Oka and Mackenzie have incorporated ethylene diamine tetra-acetic acid (EDTA) into porous silica gels [50]. EDTA is a well-known chelating agent for heavy metals [52]. Preliminary tests reveal it is possible to incorporate EDTA into porous silica microspheres (about 1.0 gm) which, upon exposure to 1.5 ml of lead solution (1000 ppm), result in a measurable reduction (by ˜50 percent) of lead (to about 500 ppm). The barely detectable fluorescence emission of EDTA does change slightly in response to lead exposure.

Organophosphonates, such as PBTC and HEDP are widely used for process control of water cooling towers, such as in controlling corrosion and antiscaling. It has demonstrated that fluorescent behavior of trivalent lanthanides, such as cerium, terbium, and europium, in solution change upon exposure to PBTC and HEDP. Unfortunately, a preliminary 9 month feasibility studied has shown that when bound into porous silica gel support, any optical changes are not easily measurable. Using other species, such as transition metal ions (absorption) and actinides (hexavalent uranium), however, rapid reversible sensors could be fabricated with short response times (under two minutes). This is more than adequate for heavily damped systems like water cooling towers. More detailed results will be published in the near future.

The first known disclosure of the incorporation of organic proteins in silica gel was by Mackenzie and Pope [53]. Braun and co-workers first demonstrated the ability to incorporate enzymes in porous gels and show bio-reactivity [54]. Ellerby et al. were able to demonstrate enzymatic sensing using doped ORMOSILS [55]. Extensive progress in understanding the fundamental science of biologically-active proteins and enzymes in sol-gel silicates has occured in recent years [56-61]. The encapsulation of five analytical coupling enzymes in silica microspheres by MATECH has been described previously [26], but is repeated here for clarity. These proteins and enzymes include R-phycoerythrin, catalase, hexokinase, luciferase, and alcohol dehydrogenase.

R-phycoerythrin is one of several useful phycobiliproteins derived from cyanobacteria and eukaryotic algea [62]. This class of proteins is highly fluorescent and has been conjugated with a wide range of antibodies and compounds. The feasibility of doping silica gel and silica microspheres with R-phycoerythrin has been demonstrated [26,59]. The fluorescence spectra of R-phycoerythrin in silica gel microspheres is virtually identical to that obtained from R-phycoerythrin in aqueous solution [26]. The incorporation of conjugated forms of this protein for specific antibody and surface antigen sensing applications holds great promise.

Catalase is well known to be an effective detector of hydrogen peroxide. The photoluminescence spectra of catalase-doped silica microspheres exposed to distilled water and to 3% hydrogen peroxide solution has been previously published. A pronounced shift in both intensity and relative peaks heights of the two diminant peaks was readily observed.

Continuous spectrophotometric rate determination is utilized in the enzymatic assay of hexokinase for glucose detection. The reaction path is as follows:

D-glucose+ATP-----(hexokinase)---? D-glucose 6-phosphate+ADP D-glucose 6-phosphate+β-NADP-----(G-6-PDH)---? 6-PG+β-NADPH where;

ATP=adenosine 5′-triphosphate,

ADP=adenosine 5′-diphosphate,

G-6-PDH=glucose-6-phosphate dehydrogenase,

β-NADP=β-nicotinamide adenine dinucleotide phosphate, oxidized form,

β-NADPH=β-nicotinamide adenine dinucleotide phosphate, reduced form.

Using these pathways, glucose detection can be measured spectroscopically with high precision. The UV-vis-nIR absorption spectra for hexokinase-doped silica gel has been published previously [26]. Experiments to co-dope with ATP and G-6-PDH and to explore alternate and reversible glucose sensing pathways are the subject of in-house research.

ATP detection employing luciferin and luciferase follows the reaction pathways, ATP+luciferin-----(firefly luciferase)---? adenyl-luciferin+PPi adenyl-luciferin+O2-----------? Oxyluciferin+CO2+light.

The fluorescence spectra of firefly luciferase in silica gel has been published previously [26]. The spectra is identical to spectra obtained for luciferase in solution. Moreover, recent unpublished results have shown that bioluminescent spectra (assays) obtained when microspheres co-doped with both luciferin and firefly luciferase are exposed to ATP are identical to the photoluminescent emission spectra. Conducting ATP assays at the end of an optical fiber is completely feasible.

Bilirubin is the most significant constituent of bile fluids secreted by the liver through the bile ducts into the duodenum. It is a breakdown product of heme formed from the degradation of erythrocyte hemoglobinin in reticuloendothelial cells, as well as other heme pigments, such as cytochromes. Bilirubin is taken up in the liver and conjugated to form bilirubin diglucuronide, which is excreted in the bile. As an intensely colored (brown) substance, its concentration in fluids can be readily detected by spectrophotometric measurements (absorption). Care, however, should be taken to eliminate any other potential sources of absorption, such as bleeding ulcers and food coloration. By “multipoint measurements” and patient fasting, these two potential sources of interference might be ruled out. While the fluorescent behavior of bilirubin is less well understood, it may be possible to develop a sensor for bilirubin based upon fluorescence, as well. Using reflectance spectroscopy, biliribin uptake within porous silica beads may be possible, particularly if a “porous mirror” can be deposited on the front end of the bead (by physical vapor deposition PVD). An array of 90 hemi-spherically “mirrored” beads has already been fabricated, demonstrating the possibility of the fabrication process.

MATECH has already demonstrated the ability to encapsulate fluorescent-labeled antibodies (fluorescein tagged HIV antibody) in silica gel microporous beads for surface antigen detection (HIV glycoprotein 120) [70]. We propose to also evaluate the potential use of labelled antibodies for the detection of legionella bacteria, associated with recirculating water cooling systems and airconditioning systems.

The inventor has evaluated the potential use of labelled antibodies for the detection of H. pylori bacteria, associated with ulcers and cancer. Labelled antibodies for H. Pylori are already commercially available. The detection strategy would be to determine spectroscopic changes (either fluorescence or absorption) which occur when the conjugated antibody comes in contact with the surface antigen (which is continuously shed by the organism). Initial efforts could be focused on simple “yes/no” detection. Future efforts could focus on a more quantitative measurement of bacterial concentration. While the bacteria is far too large to penetrate the porous silica gel beads, the surface antigens are very small. Researchers in France have shown that free floating surface antigens, shed by their cells, can easily diffuse into porous silica of a nominal 150 angstrom pore diameter [63].

Living cells manifest a wide range of highly sensitive metabolic processes and represent an opportunity to develop highly sensitive biological sensors. Challenges to developing whole cell based sensors include keeping them alive and interfacing with the cell's metabolic functions. Nonetheless, whole cell biosensing is emerging as an exciting new area of research and development. The issue of keeping the cells alive can be mitigated in in vivo sensing applications. Palti has patented the use of living tissue cells as sensors for blood and constituent levels, such as glucose monitoring [64]. One drawback to in vivo applications is the need to immunoisolate the foreign cells to avoid immunorejection reactions. Researchers at Stanford have already demonstrated how to make simple non-immunoisolated sensors from living cells [65,66]. In their work, they demonstrated ATP measurement and detection among other things.

The issue of immunoisolation has been largely resolved by our research into microbial and mammalian tissue cell encapsulation [67-71]. While the bulk of our research, which has now been spun-off into a separate company Solgene Therapeutics, LLC, has been centered around biotech drug delivery and cell therapy. For example, silica gel encapsulated pancreatic islet allografts have been successfully transplanted into severely diabetic mice, resulting in a complete remission of symptoms (glucosuria and high hematological glucose levels) for in excess of four months [67,71]. No rejection of the encapsulated foreign tissue was observed. Moreover, recent results obtained at Cornell indicate no systemic immunological response to the silica gel encapsulant (unpublished).

In the inventor's earliest work on cell encapsulation, the single cell fungi S. cerevisiae was stained with pyranine as a means of monitoring alcohol evolution during fermentation prior to encapsulation [45,46]. In this manner, we were able to optically “interface” with the living cells by monitoring changes in the fluorescence emission spectra. Thus, for in vivo applications, the solution to both key challenges of keeping the cells alive and interfacing with their metabolic functions has been demonstrated.

Researchers at ORNL have recently demonstrated the ability to attach a genetically engineered microorganism, Pseudomonas fluorescens HK44, to a hybrid circuit and detect ppb levels of naphthalene [72]. Their “critter on a chip” technology, if combined with recent cell encapsulation advances, could lead to the development of living biosensor arrays.

MATECH proposed to develop and ultimately commercialize a broad-based sensor platform technology to allow a wide range of both chemical and biological sensing functions to be performed on a single optoelectronic chip. Based upon past experience in employing sol-gel derived, highly porous silicate materials doped with fluorescent dyes and proteins, which have already been demonstrated by both MATECH and numerous other leading research groups (mostly in academia), MATECH intends to integrate them into a single MEMs based Optical Sensor Array. The challenges in successfully accomplishing this task are enormous and the resources and expertise of numerous academic and industrial collaborators will be necessary. Several key disciplines need to be “integrated” into the development and commercialization process if it is to succeed.

The MEMOSA [73] technology herein proposed relies heavily upon the knowledge and expertise gained in developing materials for fiber-optic sensing applications. Integrating numerous individual sensors into a practical and cost-effective sensor system, however, requires an approach that is based upon well established techniques, such as integrated circuit manufacturing methods. In this regard, the MEMs approach, when combined with knowledge gained from fiber-optic biosensor research, is an ideal platform to build complex, multifunctional devices on a single chip.

Referring to FIG. 6 a simple MEMs based single sensor element is shown. A thin film electroluminescent light source, already licensed by MATECH from OGI, is employed to excite the fluorescence of dye/protein doped porous silica microspheres. The emission signal is detected by a silicon based photodiode which can be easily built into the silicon wafer substrate. The trough can be etched into the silicon wafer by well-known techniques or the walls of the trough can be deposited onto the silicon wafer by well-known techniques. The silicon detector element, which has an inherently broad band wavelength sensitivity, can be “tuned” to a specific wavelength by the deposition of an optical band-pass filter on top of it. Moreover, inasmuch as a single cell is square in shape, a total of three different detectors (tuned to three different wavelengths) can be incorporated into a single sensor element. Detection can be based on the relative signal strength at each wavelength selected.

1. H. Weetal, “Nano- and MEMs Technologies for Chemical Biosensors”, NIST Program Overview, 1998 (http://www.atp.nist.gov/atp/focus/98wp-nan.htm)

2. M. J. Tierney, et al., “Fast Response Gas Sensors”, SENSORS, (October, 1992).

3. E. M. Granger, “Spectrophotometer”, U.S. Pat. No. 4,895,445 (Jan. 23, 1990).

4. J. A. Ferguson, et al., “A Fiber-Optic DNA Biosensor Microarray for the Analysis of Gene Expression”, Nature Biotechnology, 14 (December, 1996).

5. S. Borman, “DNA Chips Come of Age”, Chemical & Engineering News, (Dec. 9, 1996).

6. D. J. Lockhart, et al., “Expression Monitoring by Hybridization to High-Density Oligonucleotide Arrays”, Nature Biotechnology, 14 (December, 1996).

7. S. Tyagi, D. P. Bratu, and F. R. Kramer, “Multicolor Molecular Beacons for Allele Discrimination”, Nature Biotechnology, 16 (January, 1998).

8. A. C. Pease, et al., “Light-Generated Ligonucleotide Arrays for Rapid DNA Sequence Analysis”, Proc. Nat. Acad. Sci. USA, 91 (May 1994).

9. A. T. Woolley and R. A. Mathies, “Ultra-High-Speed DNA Fragment Separations Using Microfabricated Capillary Array Electrophoresis Chips”, Proc. Nat. Acad. Sci., USA, 91 (November, 1994).

10. U. Landegren, et al., “DNA Diagnostics—Molecular Techniques and Automation”, Science, Oct. 14, 1988).

11. T. V. Getchell, F. L. Margolis, and M. L. Getchell, “Preireceptor and Receptor Events in Vertibrate Olfaction”, Progress in Neurobiology, 23 (1984) pp. 317-345.

12. A. M. Rouhi, “Tracing Scents to an Odor Map”, Chemical & Engineering News (Dec. 23, 1996) pp.18-20.

13. T. A. Dickenson, et al., “A Chemical Detecting System Based upon a Cross-Reactive Optical Sensor Array”, Nature, 382 (22 August 1996) pp. 697-700.

14. N. S. Lewis and M. S. Freund, “Sensor Arrays for Detecting Analytes in Fluids”, U.S. Pat. No. 5,571,401 (Nov. 5, 1996).

15. S. Zhong, F. Chin, and Q. Y. Shi, “Adaptive Hierarchical Vector Quantization for Image Coding: New Results”, Optical Engineering, 34[1] (October, 1995).

16. J. A. Kane and L. Pinchuk, “Fiber-Optic Chemical Sensors Incorporating Electrostatic Coupling”, U.S. Pat. No. 5,096,671 (Mar. 17, 1992).

17. M. T. Kera, et al, “Fiber Optic Flame Detection and Temperature Measurement System Employing Doped Optical Fiber”, U.S. Pat. No. 5,051,595 (Sep. 24, 1991).

18. D. F. Gray, et al., “Dual Fiber-Optic Cell for Multiple Serum Measurements”, U.S. Pat. No. 5,176,882 (Jan. 5, 1993).

19. M. R. Wixom, “Electroluminescent Optical Fiber Shock Detection”, U.S. Pat. No. 4,991,150 (Feb. 5, 1991).

20. J. A. Kane, “Optical Probe for Measuring pH and Oxygen in Blood and Employing a Composite Membrane”, U.S. Pat. No. 4,785,814 (Nov. 22, 1988).

21. M. Uttamial and D. R. Walt, “A Fiber-Optic Carbon Dioxide Sensor for Fermentation Monitoring”, Biotechnology, 13 (June 1995) 597601.

22. N. F. Starodub, et al., “Construction and Biomedical Application of Immunosensors Based on Fiber Optics and Enhanced Chemilumunescence”, Optical Engineering, 33[9] (September 1994) pp.2958-2963.

23. E. J. A. Pope, “Fluorescence Behavior of Organic Dyes, Europium, and Uranium in Sol-Gel Microspheres”, in Sol-Gel Optics II, J. D. Mackenzie, ed. (SPIE Vol. 1758, 1992) pp.360-371.

24. E. J. A. Pope, “Process for Synthesizing Amorphous Silica Microspheres with Fluorescence Behavior”, U.S. Pat. No. 5,480,582 (Jan. 2, 1996).

25. M. L. Dakes, B. Kim, and J. Schlafer, “Method for Mounting Microsphere Coupling Lens on Optical Fibers”, U.S. Pat. No. 4,269,648 (May 26, 1981).

26. E. J. A. Pope, “Fiber Optic Chemical Microsensors Employing Optically Active Silica Microspheres”, in Advances in Fluorescence Sensing Technology II J. R. Lakowicz, ed. (SPIE Vol. 2388, 1995) pp.245-256.

27. E. J. A. Pope, “Sensor Incorporating an Optical Fiber and a Solid Porous Inorganic Microsphere”, U.S. Pat. No. 5,496,997 (Mar. 5, 1996).

28. B. D. MacCraith, et. al, “Sol-Gel Coatings for Optical Chemical Sensors and Biosensors”, in Sol-Gel Optics III, J. D. Mackenzie, ed. (SPIE Vol. 2288, 1994) pp.518-528.

29. U. Narang, et al., “Sol-Gel Derived Micron Scale Optical Fibers for Chemical Sensing”, J. Sol-Gel Sci. & Tech., 6 (1996) pp.113-119.

30. O. Ben-David, et al., “Simple Absorption Optical Fiber pH Sensor Based on Doped Sol-Gel Cladding Material”, Chem. Mater., 9 (1997) pp.2255-2257.

31. J. Samual, et al., “Miniaturization of Organically Doped Sol-Gel Materials: a Microns-Size Fluorescent pH Sensor”, Materials Letters, 21 (1994) pp.431-434.

32. F. S. Ligler, et al., “Effect of Wavelength and Dye Selection on Biosensor Response”, in Advances in Fluorescence Sensing Technology II J. R. Lakowicz, ed. (SPIE Vol. 2388, 1995) pp. 16-20.

33. E. J. A. Pope, in Chemical Processing of Ceramics, edited by B. I. Lee and E. J. A. Pope (Marcel-Dekker, New York, 1994) pp. 287-309.

34. D. Avnir, D. Levy, and R. Reisfeld, J. Phys. Chem., 88, 5956 (1984).

35. B. D. MacCraith, et al., J. Sol-Gel Sci. Tech., 2, 661 (1994).

36. B. D. MacCraith, in Sol-Gel Optics III, edited by J. D. Mackenzie (SPIE Proceedings vol. 2288, Bellingham, Wash., 1994) pp. 518-528.

37. E. J. A. Pope, in Sol-Gel Optics II, edited by J. D. Mackenzie (SPIE Proceedings vol. 1758, Bellingham, Wash., 1992) pp. 360-371.

38. E. J. A. Pope, Materials Technology, 9, 8 (1994). 39. E. J. A. Pope, in Flat-Panel Display Materials, edited byJ. Batey, et al., (Mater. Res. Soc. Proc. 345, Pittsburgh, Pa., 1994) pp.331-336.

40. E. J. A. Pope, in Sol-Gel Optics III, edited by J. D. Mackenzie (SPIE Proceedings vol. 2288, Bellingham, Wash., 1994) pp.536-545.

41. P. Lucan, et al., in Sol-Gel Optics II, edited by J. D. Mackenzie (SPIE Proceedings vol. 1758, Bellingham, Wash., 1992) pp. 464-475.

42. D. L'Esperance, et al., in Better Ceramics Through Chemistry VI, edited by A. K. Cheetham, C. J. Brinker, M. L. Mecartney, and C. Sanchez (Mater. Res. Soc. Proc. 346, Pittsburgh, Pa., 1994) pp. 579-584.

43. B. Dunn, et al, in Better Ceramics Through Chemistry III, edited by C. J. Brinker, D. E. Clark, and D. R. Ulrich (Mater. Res. Soc. Proc. 121, Pittsburgh, Pa., 1988) pp. 331-342.

44. J. C. Pouxviel, B. Dunn, and J. I. Zink, J. Phys. Chem.,93, 2134(1989).

45. E. J. A. Pope, “Gel Encapsulated Microorganisms: Saccharomyces cerevisiae—Silica Gel Biocomposites”, J. Sol-Gel Sci. & Tech., 4 (1995) pp.225-229.

46. E. J. A. Pope, “Living Ceramics” in Sol-Gel Science and Technology, edited by E. J. A. Pope, S. Sakka, and L. C. Klein (ACerS Transactions Vol. 55, Westerville, Ohio, 1995) pp. 33-49.

47. Dye Laser Principles, edited by F. J. Duarte and L. W. Hillman (Academic Press, New York, 1990).

48. E. J. A. Pope, “Fiber Optic Microsensors Using Porous, Dye Doped Silica Gel Microspheres”, in Hollow and Solid Spheres and Microspheres, ed. by M. Berg, et al., (Mat. Res. Soc. Symp. Proc. vol. 372, Pittsburgh, Pa., 1995) pp. 253-262.

49. M. J. S. Dewar, et al., Organometallics, 4, 1973 (1985).

50. K. S. Oka and J. D. Mackenzie, in Better Ceramics Through Chemistry VI, edited by A. K. Cheetham, C. J. Brinker, M. L. Mecartney, and C. Sanchez (Mater. Res. Soc. Proc. 346, Pittsburgh, Pa., 1994) pp. 323-328.;

51. P. W. Wong and J. D. Mackenzie, in Better Ceramics Through Chemistry VI, edited by A. K. Cheetham, C. J. Brinker, M. L. Mecartney, and C. Sanchez (Mater. Res. Soc. Proc. 346, Pittsburgh, Pa., 1994) pp. 329-333.

52. H. Ogino and M. Shimura, in Advances in Inorganic and Bioinorganic Mechanisms IV, (Academic Press, Inc., London, 1986) 107.

53. J. D. Mackenzie and E. J. A. Pope, U.S. Pat. No. 5,215,942 (Jun. 1, 1993) [filed Aug. 15, 1988, disclosed to University of California Mar. 13, 1986]. The patent (in claim 16) describes the addition of “organic glucoses, organic dextroses, organic proteins and cellulose derivatives” to sol-gel derived silica.

54. S. Braun, et al., Mater. Lett., 10, 1 (1990).

55. L. M. Ellerby, et al., “Encapsulation of Proteins in Transparent Porous Silicate Glasses Prepared by the Sol-Gel Method”, Science, 255, (1992) pp. 1113-1115.

56. B. C. Dave, et al., “Sol-Gel Encapsulation Methods for Biosensors”, Analytical Chemistry, 66 (1994) pp.1120A-1127A.

57. D. Avnir, et al., “Enzymes and Other Proteins Entrapped in Sol-Gel Materials”, Chem. Mater., 6(1994) pp.1605-1614.

58. D. Avnir, “Organic Chemistry within Ceramic Matrices: Doped Sol-Gel Materials”, Acc.Chem.Res., 28(1995) pp.328-334.

59. Z. Chen, et al., “Sol-Gel Encapsulated Light-Transducing Protein Phycoerythrin: A New Biomaterial”, Chem. Mater., 7(1995) pp.1779-1783.

60. A. Turniansky, et al., “Sol-Gel Entrapment of Monoclonal Anti-Atrazine Antibodies”, J. Sol-Gel Sci. & Tech., 7(1996) pp.135-143.

61. “Biomedical Aspects”, S. Braun and D. Avnir, guest editors, J. Sol-Gel Sci. & Tech., 7[1/2](1996).

62. R. P. Haugland, Handbook of Fluorescent Probes and Research Chemicals, (Molecular Probes, Inc., Eugene, Oreg., 1992) pp. 77-79.

63. J. Livage, et al., “Optical Detection of Parasitic Protozoa in Sol-Gel Matrices”, in Sol-Gel Optics III, edited by J. D. Mackenzie (SPIE Proceedings vol. 2288, Bellingham, Wash., 1994) pp.493-503.

64. Y. Palti, “System for Monitoring and Controlling Blood and Tissue Constituent Levels”, U.S. Pat. No. 5,368,028 (Nov. 29, 1994). This patent traces itself back to a patent issued Aug. 11, 1989, U.S. Pat. No. 5,101,814.

65. J. B. Shear, et al., “Single Cells as Biosensors for Chemical Separations”, Science, 267 (6 January 1995) pp. 74-77.

66. “Making a Biosensor from a Cell and a Fluorescent Dye”, Biophotonics, (March/April 1995) p.17.

67. E. J. A. Pope, K. Braun, and C. M. Peterson, “Bioartificial Organs I: Silica Gel Encapsulated Pancreatic Islets for the Treatment of Diabetes Mellitus”, J. Sol-Gel Sci. & Tech., 8 (1997) pp. 635-639.

68. E. J. A. Pope, “Encapsulation of Living Tissue Cells in an Organosilicon”, U.S. Pat. No. 5,693,513 (Dec. 2, 1997).

69. E. J. A. Pope, “Encapsulation of Animal and Microbial Cells in an Inorganic Gel Prepared from an Organosilicon”, U.S. Pat. No. 5,739,020 (Apr. 14, 1998).

70. E. J. A. Pope, U.S. & foreign patents pending.

71. K. P. Peterson, C. M. Peterson, and E. J. A. Pope, “Silica Sol-Gel Encapsulation of Pancreatic Islets”, Proc. Soc. Exp'l Bio. & Med., accepted, in press.

72. K. G. Tatterson, “Bioluminescent ‘critters’ make chip sensitive to air contaminants”, Biophotonics International, (July/August, 1997) 33.

73. E. J. A. Pope, U.S. & foreign patents pending.

Referring to FIG. 7 through FIG. 12 there are alternative designs such as when the individual sensor elements are inverse pyramidal in shape. Once again, three different detectors, tuned to three wavelengths, allows the sensor to act as a crude spectrophotometer. In this design, however, a thin porous mirror is applied to the top of the sensor array (already demonstrated by MATECH for microsphere based arrays). The high surface area doped sol-gel material is deposited into each inverted pyramidal shaped element. Each element can be doped with a different dye, enzyme, or protein tailored to a specific species. As described in sections 2 and 3, the signals from each element of the array can be analyzed to produce a “map” of the unknown compound or mixture and compared to an established data base of references. In this manner the presence of toxic chemicals, heavy metals, food born biological pathogens, biological warfare agents, chemical warfare agents, and diseases known to attach humans and animals can all be detected rapidly from a single small sample of vapor or fluid.

Referring to FIG. 13 current “state of the art” biochips use fluorescence consist of patterned microarrays for DNA and RNA detection. These micro-arrays are, usually patterned on glass slides, are inserted into large analytical instruments in order to obtain detection results. By integrating the entire instrument onto the chip the world's smallest spectrophotometer can be created. The entire instrument will be disposable. This instrumentation platform can be extremely versatile inasmuch as it will be portable, battery operated, and capable of deployment in remote locations and even locations that are unsuitable or unsafe for human presence. The key principles and requirements are that: 1) all light sources must be on the chip; 2) all optical detectors (at different wavelengths) be on the chip; and 3) the relevant bioactive materials be on the chip. The chip will only require power and will produce only electrical output signals.

Referring to FIG. 14 the chip can potentially have two modes of operation, transmission spectrophotometry and fluorescence spectrophotometry. A prototype octahedral “sensel” has two different light sources, a UV electroluminescent (EL) material and a white EL material and six amorphous silicon detectors. Each amorphous silicon detector should be tuned to a different wavelength range using an optical band-pass filter coating. In transmission mode, the white EL is activated and the transmission spectra of the bioactive material is measured. In fluorescence mode, the UV EL material is activated and the fluorescence spectra of the bioactive material is measured.

Referring to FIG. 15 whether in transmission mode or fluorescence mode, the six detectors will produce an electrical output signal as a function of the light intensity at each of the six detectors wavelengths that can be viewed as a histogram.

Referring to FIG. 16 another way to plot the output data is to plot it as an emission or transmission spectra (depending upon the mode of operation) and curve fit the six data points. Signal processing and interpretation is an important aspect of the chip's design and function.

Referring to FIG. 17 one possible design of each sensel would be inverted octagonal “pyramids” defining a depression in which the bioactive material can be deposited. There are numerous possible ways of depositing the bioactive material to be photometrically evaluated. One method would be to use microspheres. Microspheres could be placed in each well and attached with adhesive. The advantage that this approach offers is that the electro-optical substrate of the arrays could be fabricated identically. The bioactive function of each array can be customized for a specific application through the selection of the microspheres to be placed in it. The microspheres utilized can be porous or dense, organic or inorganic, depending upon the specific biological and/or chemical interaction being investigated. For example, sol-gel derived porous microspheres containing a wide range of biological enzymes could be used. Alternatively, non-porous beads with fluorescent dye conjugated antibodies bound to their outer surfaces could be used for antigen detection. A very wide range of possible biological and chemical assays could be integrated into the chip.

Referring to FIG. 18 another possible design for sensels is based upon the same underlying electro-optic array, but with a significant difference—the bioactive material would be cast in place in each well. Whether using polymeric organic gels or sol-gel derived porous silica, the wet gel octagonal bioactive materials would be pipetted into each well and gelled in place. On top of the array, a thin, porous reflective polymer layer would be applied. This layer would permit analytes to permeate the bioactive gel underneath. The reflectivity of the layer would assure that much of the light would not be lost outside the plane of the chip. The key to the BioOptix chip is the ability to have a large plurality of sensels on a single chip of very small dimensions.

Referring to FIG. 19 a simple 64 sensel chip is illustrated. As the technology advances, it should be possible to fabricate a chip of no more than 1.0 cm in size with in excess of 10,000 individual sensel elements.

Referring to FIG. 20 in conjunction with FIG. 21 in order to fully exploit the potential of the BioOptix chip, a wide range of biological assays will need to be integrated into the chip's “portfolio” of bioactive detection systems. These include assays for molecular biology, immunoassays, enzymatic assays, and receptor-ligand assays. For molecular biology and enzymatic assays, porous sol-gel derived silica microspheres doped with the appropriate fluorophor-labeled enzymes is an attractive bioactive materials platform.

Referring to FIG. 22 it has been demonstrated using microarray technology that protein-protein interactions can be quantitatively measured using fluorescence. For much larger detection targets, such as antigen-specific IgG, surface binding interactions can be utilized using microspheres.

The bioactive components of the BioOptix chip need to be either embedded or attached to a variety of substrate materials to optimize their function and assure sensitivity and attain reproducible and quantifiable results.

One of the exciting applications of the BioOptix chip might include the development of a “one drop” blood chem panel-the almost instantaneous analysis of blood chemistry using a single drop of blood. The market for microarray technology has been growing rapidly in the past few years. There are numerous companies involved in many different aspects of microarray technology (see company list below). Conventional microarray technology utilizes a pattern of densely packed bioactive “spots” that are “spotted” onto a glass slide using a robotic “spotter”. After exposure to the sample that is to be analyzed, the microarray is inserted into a microarray reader, which is a large instrument with a light source and sophisticated detection system (often a CCD array). These systems are large and not portable. The BioOptix chip requires the deposition of 2 different electro-luminescent light sources, six amorphous silicon photo-detectors (each with a different optical band-pass filter deposited on top of it), and 16 electrical connections to each individual sensel. All of these must be fabricated onto the surfaces of octagonal inverted pyramidal indentations. Therefore, the challenges in fabricating the electro-optic platform are considerable.

The output signals from each sensel will need to be processed by software capable of signal pattern recognition. Signal processing is integral to the function of the Biooptix chip.

1. U.S. Pat. No. 5,480,582, issued Jan. 2, 1996, E. J. A. Pope, “Process for Synthesizing Amorphous Silica Microspheres with Fluorescence Behavior”.

2. U.S. Pat. No. 5, 496, 997 issued Mar. 5, 1996, E. J. A. Pope, “Sensor incorporating an optical fiber and a solid, porous, inorganic microsphere”.

3. E. J. A. Pope, “Fluorescence Behavior of Organic Dyes, Europium, and Uranium in Sol-Gel Microspheres,” in Sol-Gel Optics II, J. D. Mackenzie, ed (SPIE vol. 1758, 1992) pp.360-371.

4. E. J. A. Pope, “Dye-doped Silicate Matrices”, Proceedings of the International Conference on LASERS '93, V. J. Corcoran and T. A. Goldman, eds. (STS Press, McLean, VA:1994)372-379.

5. E. J. A. Pope, “Luminescent Microspheres for Improved Flat-panel Color Displays”, Materials Technology, 9(1994)8-9.

6. E. J. A. Pope, “Fiber-Optic Microsensors using Porous, Dye-Doped Silica Gel Microspheres”, in Hollow and Solid Spheres and Microspheres, edited by D. L. Wilcox, et al, (Mat. Res. Soc. Symp. Proc.vol. 372, 1995) 253-262.

7. E. J. A. Pope, “Fiber optic chemical microsensors employing optically active silica microspheres”, in Advances in Fluorescence Sensing Technology II, ed. by J. R. Lakowicz, (SPIE Conf. Proc. 2388,1995) 245-256.

8. E. J. A. Pope, “Sol-Gel Chemical and Biological Fiber-Optic Sensors and Fluorometric Sensor Arrays”, in Sol-Gel Optics V, B. S. Dunn, E. J. A. Pope, H. K. Schmidt, and M. Yamane, eds. (S.P.I.E., Volume 3943, Bellingham, Wash., 2000).

9. T. A. Taton, C. A. Mirkin, and R. L. Letsinger, “Scanometric DNA Array Detection with Nanoparticle Probes”, Science Vol. 289 (Sep. 8, 2000) pp. 1757-1760.

10. G. MacBeath and S. L. Schreiber, “Printing Proteins as Microarrays for High-Throughput Function Determination”, Science Vol. 289 (Sep. 8, 2000) pp. 1760-1763.

The BioOptix Project seeks to develop the world's first spectrophotometer microarray biochip platform. Current “state of the art” biochips using fluorescence consist of patterned microarrays for DNA and RNA detection. These microarrays, usually patterned on glass slides, are inserted into large analytical instruments in order to obtain detection results. We seek to fully integrate the instrument and the biochip array into one device. By integrating the entire instrument onto the chip, we will be creating the world's smallest spectro-photometer. In addition, the entire instrument will be disposable. This instrumentation platform can be extremely versatile inasmuch as it will be portable, battery operated, and capable of deployment in remote locations and even locations that are unsuitable or unsafe for human presence.

The key principles and requirements in the design and fabrication of the BioOptix chip technology are that: 1) all light sources must be on the chip; 2) all optical detectors (at different wavelengths) must be on the chip, and; 3) the relevant bioactive materials must be on the chip. The chip will only require power and will produce only electrical output signals.

The Biooptix chip can potentially have two modes of operation, transmission spectrophotometry and fluorescence spectrophotometry.

In order to fully exploit the potential of the BioOptix chip, a wide range of biological assays will need to be integrated into the chip's “portfolio” of bioactive detection systems. These include assays for molecular biology, immunoassays, enzymatic assays, and receptor-ligand assays. For molecular biology and enzymatic assays, porous sol-gel derived silica microspheres doped with the appropriate fluorophor-labeled enzymes is an attractive bioactive materials platform. It has already been demonstrated using microarray technology that protein-protein interactions can be quantitatively measured using fluorescence. For much larger detection targets, such as antigen-specific IgG, surface binding interactions can be utilized using microspheres.

The bioactive components of the BioOptix chip need to be either embedded or attached to a variety of substrate materials to optimize their function and assure sensitivity and attain reproducible and quantifiable results. Materials skills involved include, but are not limited to, sol-gel chemistry and organic polymer chemistry.

Inasmuch as the BioOptix chip is essentially an array to microscopic transmission and fluorescence spectrophotometers, good optical engineering design and performance is critical to their function.

Most of the assays of potential interest are biochemically based. Target analytes include DNA, antibodies, enzymes, and receptors. The development of, and/or modification of existing assays, to the BioOptix platform requirements will be extensively required.

One of the exciting applications of the Biooptix chip might include the development of a “one drop” blood chem panel-the almost instantaneous analysis of blood chemistry using a single drop of blood.

The market for microarray technology has been growing rapidly in the past few years. There are numerous companies involved in many different aspects of microarray technology (see company list below). Conventional microarray technology utilizes a pattern of densely packed bioactive “spots” that are “spotted” onto a glass slide using a robotic “spotter”. After exposure to the sample that is to be analyzed, the microarray is inserted into a microarray reader, which is a large instrument with a light source and sophisticated detection system (often a CCD array). These systems are large and not portable. The BioOptix chip requires the deposition of 2 different electroluminescent light sources, six amorphous silicon photodetectors (each with a different optical band-pass filter deposited on top of it), and 16 electrical connections to each individual sensel. All of these must be fabricated onto the surfaces of octagonal inverted pyramidal indentations. Therefore, the challenges in fabricating the electro-optic platform are considerable. The output signals from each sensel will need to be processed by software capable of signal pattern recognition. Signal processing is integral to the function of the BioOptix chip has been described.

While this invention has been particularly shown and described with references to preferred embodiments thereof, it will be understood by those skilled in the art that various changes in form and details may be made therein without departing from the spirit and scope of the invention as defined by the appended claims It should be noted that the sketches are not drawn to scale and that distance of and between the figures are not to be considered significant.

Accordingly it is intended that the foregoing disclosure and showing made in the drawing shall be considered only as an illustration of the principle of the present invention.

What is claimed is:

1. A chip comprising a plurality of sensors.

2. A chip of claim 1 comprising a plurality of sensors, each of which contains one or more light sources and one or more optical detectors.

3. A chip of claim 2 in which the light source is an electro-luminescent material.

4. A chip of claim 2 in which the light source is an organic electroluminescent material.

5. A chip of claim 2 in which the light source is an inorganic electroluminescent material.

6. A chip of claim 2 in which the light source is connected by conductive electrodes.

7. A chip of claim 2 in which the detector is a semiconducting material.

8. A chip of claim 2 in which the detector is composed of amorphous silicon.

9. A chip of claim 2 in which the detector is tuned to respond to a specific wavelength range of light.

10. A chip of claim 2 with multiple detectors in which each detector is tuned to a different wavelength range of light.

11. A chip of claim 2 with multiple detectors in which each detector is tuned to a different wavelength range of light and the output of these detectors produces a spectra.

12. A chip of claim 2 with multiple detectors in which each detector is tuned to a different wavelength range of light and each detector is connected by conductive electrodes.

13. A chip of claim 2 in which each sensor is coupled to a bioactive material.

14. A chip of claim 2 in which each sensor is coupled to a protein.

15. A chip of claim 2 in which each sensor is coupled to an antibody.

16. A chip of claim 2 in which each sensor is coupled to a fluorescence-labeled antibody.

17. A chip of claim 2 in which each sensor is coupled to an organic dye.

18. A chip of claim 2 in which each sensor is coupled to a porous gel.

19. A chip of claim 2 in which each sensor is coupled to a porous gel doped with an organic dye.

20. A chip of claim 2 in which each sensor is coupled to a porous gel doped with a protein or enzyme.

21. A chip of claim 2 in which each sensor is coupled to a porous gel containing an antibody.

22. A chip of claim 2 in which each sensor is coupled to a porous gel encapsulating a living cell.

23. A chip of claim 2 in which each sensor is coupled to a porous silica gel.

24. A chip of claim 2 in which each sensor is coupled to a porous silica gel doped with an organic dye.

25. A chip of claim 2 in which each sensor is coupled to a porous silica gel doped with a protein or enzyme.

26. A chip of claim 2 in which each sensor is coupled to a porous silica gel containing an antibody.

27. A chip of claim 2 in which each sensor is coupled to a porous silica gel encapsulating a living cell.

28. A chip of claim 2 in which each sensor is coupled to a porous silica gel microsphere.

29. A chip of claim 2 in which each sensor is coupled to a porous silica gel microsphere doped with an organic dye.

30. A chip of claim 2 in which each sensor is coupled to a porous silica gel microsphere doped with a protein or enzyme.

31. A chip of claim 2 in which each sensor is coupled to a porous silica gel microsphere containing an antibody.

32. A chip of claim 2 in which each sensor is coupled to a porous silica gel microsphere encapsulating a living cell.
